(19) United States
(12) Patent Application Publication
(10) Pub. No.: US 2026/0239080 A1
(43) Pub. Date: Aug. 13, 2026

(54) CONFIGURING AND REPORTING OF UE STATIONARY CONDITION INFORMATION FOR WIRELESS NETWORKS

(71) Applicant: NOKIA TECHNOLOGIES OY, Espoo (FI)

(72) Inventors: Anna PANTELIDOU, Antony (FR); Ethiraj ALWAR, Karnataka (IN); Sankaran BALASUBRAMANIAM, Karnataka (IN)

(21) Appl. No.: 19/470,757

(22) PCT Filed: Feb. 7, 2024
(86) PCT No.: PCT/EP2024/053082

§ 371 Date: Sep. 29, 2025

(30) Foreign Application Priority Data
Apr. 7, 2023 (IN) 202341026205

(51) Int. Cl. H04W 24/10; H04W 64/00

(52) U.S. Cl. CPC H04W 24/10; H04W 64/006

(57) ABSTRACT

A method includes receiving, by a user device, a configuration for determining and reporting a stationary condition monitoring area, wherein inside the stationary monitoring area the user device is considered to be in a stationary condition, and outside the stationary monitoring area the user device is considered to be in a non-stationary condition, the configuration including information indicating the stationary monitoring area; determining the stationary condition information for the user device based on the stationary monitoring area; and transmitting, by the user device to a network node, a report including the stationary condition information for the user device.

### TECHNICAL FIELD

This description relates to wireless communications.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3rd Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP's Long Term Evolution (LTE) upgrade path for mobile networks. In LTE, base stations or access points (APs), which are referred to as enhanced Node AP (eNBs), provide wireless access within a coverage area or cell. In LTE, mobile devices, or mobile stations are referred to as user equipments (UE). LTE has included a number of improvements or developments. Aspects of LTE are also continuing to improve.

5G New Radio (NR) development is part of a continued mobile broadband evolution process to meet the requirements of 5G, similar to earlier evolution of 3G and 4G wireless networks. In addition, 5G is also targeted at the new emerging use cases in addition to mobile broadband. A goal of 5G is to provide significant improvement in wireless performance, which may include new levels of data rate, latency, reliability, and security. 5G NR may also scale to efficiently connect the massive Internet of Things (IoT) and may offer new types of mission-critical services. For example, ultra-reliable and low-latency communications (URLLC) devices may require high reliability and very low latency.

### SUMMARY

A method may include receiving, by a user device, a configuration for determining and reporting a stationary condition information for the user device with respect to a stationary monitoring area, wherein inside the stationary monitoring area the user device is considered to be in a stationary condition, and outside the stationary monitoring area the user device is considered to be in a non-stationary condition, the configuration including information indicating the stationary monitoring area; determining the stationary condition information for the user device based on the stationary monitoring area; and transmitting, by the user device to a network node, a report including the stationary condition information for the user device.

An apparatus may include at least one processor; and at least one memory including computer program code; the at least one memory and the computer program code configured to, with the at least one processor, cause the apparatus at least to: receive, by a user device, a configuration for determining and reporting a stationary condition information for the user device with respect to a stationary monitoring area, wherein inside the stationary monitoring area the user device is considered to be in a stationary condition, and outside the stationary monitoring area the user device is considered to be in a non-stationary condition, the configuration including information indicating the stationary monitoring area; determine the stationary condition information for the user device based on the stationary monitoring area; and transmit, by the user device to a network node, a report including the stationary condition information for the user device.

Other example embodiments are provided or described for each of the example methods, including: means for performing any of the example methods; a non-transitory computer-readable storage medium comprising instructions stored thereon that, when executed by at least one processor, are configured to cause a computing system to perform any of the example methods; and an apparatus including at least one processor, and at least one memory including computer program code, the at least one memory and the computer program code configured to, with the at least one processor, cause the apparatus at least to perform any of the example methods.

The details of one or more examples of embodiments are set forth in the accompanying drawings and the description below. Other features will be apparent from the description and drawings, and from the claims.

### BRIEF DESCRIPTION OF THE DRAWINGS

FIG. 1 is a block diagram of a wireless network according to an example embodiment.

FIG. 2 is a flow chart illustrating operation of a user device or UE.

FIG. 3 is a diagram illustrating two stationary monitoring areas.

FIG. 4 is a diagram illustrating how a condition of the UE (e.g., stationary condition or non-stationary condition can be evaluated with respect to different RRC states)

FIG. 5 is a diagram illustrating configuring a UE, and the UE logging and reporting stationary condition information based on the received stationary evaluation configuration.

FIG. 6 is a diagram illustrating operation where a stationary monitoring area is based on a list of beams (e.g., SSBs/SSB beams) and the UE transitions from a stationary condition to a non-stationary condition.

FIG. 7 is a diagram illustrating operation where a stationary monitoring area is based on a list of beams and the idle state or inactive state UE transitions from a stationary condition to a non-stationary condition.

FIG. 8 is a block diagram of a wireless station or node (e.g., network node, user node or UE, relay node, or other node).

### DETAILED DESCRIPTION

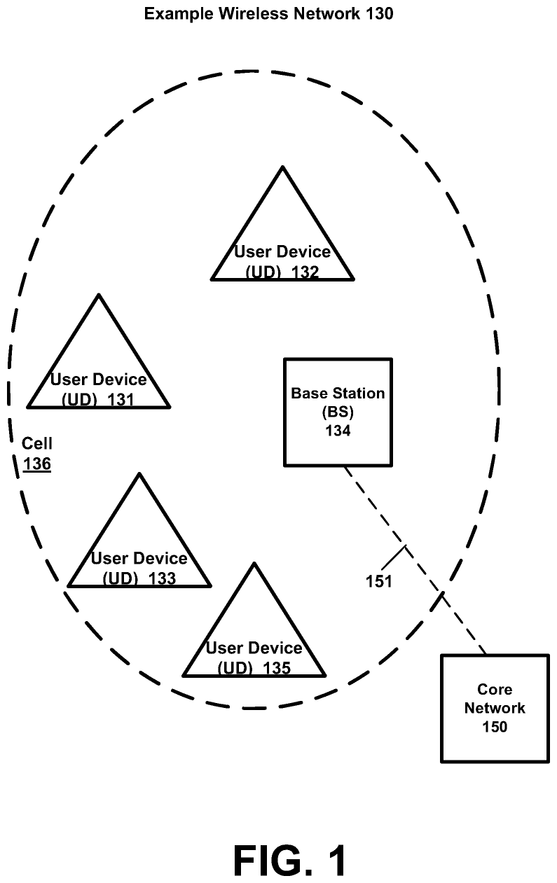

FIG. 1 is a block diagram of a wireless network 130 according to an example embodiment. In the wireless network 130 of FIG. 1, user devices 131, 132, 133 and 135, which may also be referred to as mobile stations (MSs) or user equipment (UEs), may be connected (and in communication) with a base station (BS) 134, which may also be referred to as an access point (AP), an enhanced Node B (eNB), a gNB or a network node. The terms user device and user equipment (UE) may be used interchangeably. A BS may also include or may be referred to as a RAN (radio access network) node, and may include a portion of a BS or a portion of a RAN node, such as (e.g., such as a centralized unit (CU) and/or a distributed unit (DU) in the case of a split BS or split gNB). At least part of the functionalities of a BS (e.g., access point (AP), base station (BS) or (e)Node B (eNB), gNB, RAN node) may also be carried out by any node, server or host which may be operably coupled to a transceiver, such as a remote radio head. BS (or AP) 134 provides wireless coverage within a cell 136, including to user devices (or UEs) 131, 132, 133 and 135. Although only four user devices (or UEs) are shown as being connected or attached to BS 134, any number of user devices may be provided. BS 134 is also connected to a core network 150 via a S1 interface 151. This is merely one simple example of a wireless network, and others may be used.

A base station (e.g., such as BS 134) is an example of a radio access network (RAN) node within a wireless network. A BS (or a RAN node) may be or may include (or may alternatively be referred to as), e.g., an access point (AP), a gNB, an eNB, or portion thereof (such as a/centralized unit (CU) and/or a distributed unit (DU) in the case of a split BS or split gNB), or other network node.

According to an illustrative example, a BS node (e.g., BS, eNB, gNB, CU/DU, . . . ) or a radio access network (RAN) may be part of a mobile telecommunication system. A RAN (radio access network) may include one or more BSs or RAN nodes that implement a radio access technology, e.g., to allow one or more UEs to have access to a network or core network. Thus, for example, the RAN (RAN nodes, such as BSs or gNBs) may reside between one or more user devices or UEs and a core network. According to an example embodiment, each RAN node (e.g., BS, eNB, gNB, CU/DU, . . . ) or BS may provide one or more wireless communication services for one or more UEs or user devices, e.g., to allow the UEs to have wireless access to a network, via the RAN node. Each RAN node or BS may perform or provide wireless communication services, e.g., such as allowing UEs or user devices to establish a wireless connection to the RAN node, and sending data to and/or receiving data from one or more of the UEs. For example, after establishing a connection to a UE, a RAN node or network node (e.g., BS, eNB, gNB, CU/DU, . . . ) may forward data to the UE that is received from a network or the core network, and/or forward data received from the UE to the network or core network. RAN nodes or network nodes (e.g., BS, eNB, gNB, CU/DU, . . . ) may perform a wide variety of other wireless functions or services, e.g., such as broadcasting control information (e.g., such as system information or on-demand system information) to UEs, paging UEs when there is data to be delivered to the UE, assisting in handover of a UE between cells, scheduling of resources for uplink data transmission from the UE(s) and downlink data transmission to UE(s), sending control information to configure one or more UEs, and the like. These are a few examples of one or more functions that a RAN node or BS may perform.

A user device or user node (user terminal, user equipment (UE), mobile terminal, handheld wireless device, etc.) may refer to a portable computing device that includes wireless mobile communication devices operating either with or without a subscriber identification module (SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, a vehicle, a sensor, and a multimedia device, as examples, or any other wireless device. It should be appreciated that a user device may also be (or may include) a nearly exclusive uplink only device, of which an example is a camera or video camera loading images or video clips to a network. Also, a user node may include a user equipment (UE), a user device, a user terminal, a mobile terminal, a mobile station, a mobile node, a subscriber device, a subscriber node, a subscriber terminal, or other user node. For example, a user node may be used for wireless communications with one or more network nodes (e.g., gNB, eNB, BS, AP, CU, DU, CU/DU) and/or with one or more other user nodes, regardless of the technology or radio access technology (RAT). In LTE (as an illustrative example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks. Other types of wireless networks, such as 5G (which may be referred to as New Radio (NR)) may also include a core network.

In addition, the techniques described herein may be applied to various types of user devices or data service types, or may apply to user devices that may have multiple applications running thereon that may be of different data service types. New Radio (5G) development may support a number of different applications or a number of different data service types, such as for example: machine type communications (MTC), enhanced machine type communication (eMTC), Internet of Things (IoT), and/or narrowband IoT user devices, enhanced mobile broadband (eMBB), and ultra-reliable and low-latency communications (URLLC). Many of these new 5G (NR)—related applications may require generally higher performance than previous wireless networks.

IoT may refer to an ever-growing group of objects that may have Internet or network connectivity, so that these objects may send information to and receive information from other network devices. For example, many sensor type applications or devices may monitor a physical condition or a status, and may send a report to a server or other network device, e.g., when an event occurs. Machine Type Communications (MTC, or Machine to Machine communications) may, for example, be characterized by fully automatic data generation, exchange, processing and actuation among intelligent machines, with or without intervention of humans. Enhanced mobile broadband (eMBB) may support much higher data rates than currently available in LTE.

Ultra-reliable and low-latency communications (URLLC) is a new data service type, or new usage scenario, which may be supported for New Radio (5G) systems. This enables emerging new applications and services, such as industrial automations, autonomous driving, vehicular safety, e-health services, and so on. 3GPP targets in providing connectivity with reliability corresponding to block error rate (BLER) of 10-5 and up to 1 ms U-Plane (user/data plane) latency, by way of illustrative example. Thus, for example, URLLC user devices/UEs may require a significantly lower block error rate than other types of user devices/UEs as well as low latency (with or without requirement for simultaneous high reliability). Thus, for example, a URLLC UE (or URLLC application on a UE) may require much shorter latency, as compared to an eMBB UE (or an eMBB application running on a UE).

The techniques described herein may be applied to a wide variety of wireless technologies or wireless networks, such as 5G (New Radio (NR)), cmWave, and/or mmWave band networks, IoT, MTC, eMTC, eMBB, URLLC, 6G, etc., or any other wireless network or wireless technology. These example networks, technologies or data service types are provided only as illustrative examples.

It may be desirable for a network to determine or obtain an estimate of whether, and/or to the extent that, a UE (or user device) (or a group of UEs) may be stationary. There are currently no techniques available for configuring a UE to determine its stationary condition (e.g., whether the UE is stationary or non-stationary), to configure various types or levels of being stationary (or stationariness), nor for the UE to report its stationary condition (e.g. whether the UE is stationary or non-stationary).

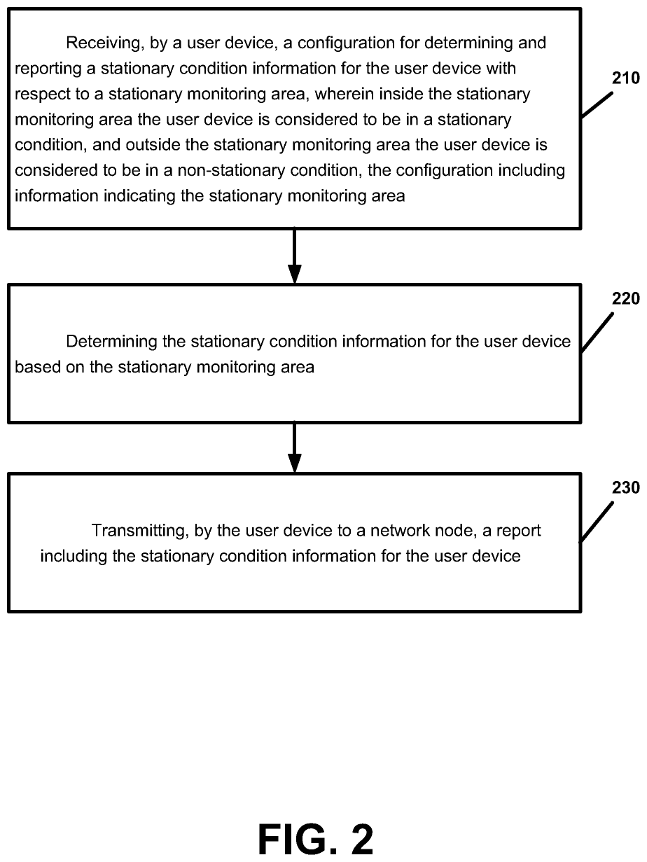

FIG. 2 is a flow chart illustrating operation of a user device or UE. The following text and figures describe examples, illustrative details, operations and/or other features with respect to the method illustrated in FIG. 2.

With respect to FIG. 2, operation 210 includes receiving, by a user device (e.g., UE), a configuration (e.g., such as a stationary evaluation configuration) for determining and reporting (e.g., to configure or cause the user device or UE to determine and report) a stationary condition information for the user device with respect to a stationary monitoring area (e.g., where the stationary monitoring area may be or may include one or more locations, an area or group of areas (which may correspond to a plurality of locations), one or more cells, and/or one or more beams) wherein inside the stationary monitoring area the user device is considered to be in a stationary condition, and outside the stationary monitoring area the user device is considered to be in a non-stationary condition, the configuration including information indicating the stationary monitoring area.

With respect to FIG. 2, operation 220 includes determining the stationary condition information for the user device based on the stationary monitoring area. For example, determining stationary condition information for the user device (or UE) may include, for example, determining whether the user device is in a stationary condition or in a non-stationary condition with respect to the stationary monitoring area. The stationary condition information may include additional information. This additional information (e.g., in addition to the condition of the user device as either stationary condition or non-stationary condition) may include information such as time, timing or time duration information that may include a time instant when the condition is determined and/or a duration that the user device is in the determined condition, and/or location information for the user device. Location information for a user device may include a location (also known as position) of the user device, a beam the user device is using for communication while in a connected state or a strongest beam measured by the user device while in an idle or inactive state, and/or a cell the user device is connected to in a connected state or a strongest cell the user device has measured while in an idle or inactive state when or while the condition (stationary or non-stationary condition) of the user device is determined. The condition of the user device may be detected or determined one or more times.

With respect to FIG. 2, operation 230 includes transmitting, by the user device to a network node, a report including the stationary condition information for the user device. The stationary condition information may be logged (e.g., stored or recorded at the UE) while the UE is in an idle or inactive state, and then the report may be transmitted to a network node when the UE establishes a connection to the network node. Alternatively, the report including the stationary condition information for the user device may be directly transmitted by the user device to the network node while the user device is in a connected state. Additional figures and text herein provide further details, operations and/or features with respect to the method of FIG. 2.

Transmitting may mean or may include preparing a signal for being transmitted and/or carrying out the transmission via RF (radio frequency or wireless) parts or components (e.g., wireless transmitter, amplifier, filter, and the like) and antenna. Correspondingly, receiving may mean or may include carrying out signal reception, monitoring, decoding, etc., via RF parts or components (e.g., wireless receiver, amplifier, filter, detector, demodulator, and the like) and antenna or, for example, and may include a signal detection (and/or signal detection, decoding and/or demodulation process carried out (or assisted in being carried out) by a processor.

A stationary condition (or stationariness), which may indicate whether a UE is stationary or non-stationary, or may indicate a degree, an amount or extent that a UE is stationary, may be, or may include, whether a UE is geographically or physically stationary (e.g., the UE is within a specific area, one or more locations, or within or inside a set of one or more cells), or spatially stationary (e.g., the UE uses a beam of or part of a set of one or more beams). Thus, a condition of a UE (e.g., UE in a stationary condition or in a non-stationary condition) may be determined with respect to a stationary monitoring area., e.g., which may be or may include a location, a group of locations or an area, one or more cells (e.g., a set of cells), or one or more beams (e.g., a set of beams). Thus, a UE's condition (e.g., UE being in a stationary condition or in a non-stationary condition), or a UE's amount or degree of being stationary, may be measured or determined with respect to the stationary monitoring area.

A stationary monitoring area may include, e.g., one or more locations, an area, one or more cells, or one or more beams, for example. Thus, as described herein, a UE in a connected state may be in a stationary condition, e.g., where the UE has a location inside an area of the stationary monitoring area, or is connected to a cell within the one or more cells of a stationary monitoring area, or is communicating via a beam or has selected for communication the beam that is a beam of a set of one or more beams of a stationary monitoring area. Also, for example, a UE in a connected state may be in a non-stationary condition, e.g., where the UE has a location that is outside of an area of the stationary monitoring area, or is connected to a cell that is not within or part of the one or more cells of a stationary monitoring area, or the UE is communicating via, or has selected for communications, a beam that is part of a stationary monitoring area (e.g., stationary monitoring area specified as a set of one or more beams).

While a UE is in an idle or inactive state, the UE, for example, may be in a stationary condition, e.g., if the UE has a location within a group of locations or an area of the stationary monitoring area, has detected or measured a strongest cell (e.g., has measured a beam or reference signal from a cell that is the strongest signal) that is within or part of the one or more cells of the stationary monitoring area, or has detected or measured a strongest beam that is a beam within or part of the one or more beams of the stationary monitoring area. Also, for example, while a UE is in an idle or inactive state, the UE may be in a non-stationary condition if the UE has a location that is outside of a group of locations or outside of an area of the stationary monitoring area, has detected or measured a strongest cell (e.g., has measured a beam or reference signal from a cell that is the strongest signal) that is not part of the one or more cells of the stationary monitoring area, or has detected or measured a strongest beam that is not part of (or not one of the beams of) the one or more beams of the stationary monitoring area.

Furthermore, the configuration (e.g., stationary evaluation configuration, to cause the UE to determine and report its condition as either a stationary condition, or a non-stationary condition) may include multiple configurations, e.g., including a first configuration for connected state UE evaluation of the UE's condition, and a second configuration for idle state or inactive state UE evaluation of the UE's condition. For example, the configuration (e.g., stationary evaluation configuration) may include a first configuration, including a first evaluation condition or a first stationary monitoring area, to be used by the UE while in an idle state or inactive state to determine a condition of the UE as either the stationary condition or the non-stationary condition; and a second configuration, including a second evaluation condition or a second stationary monitoring area that is different than the first evaluation condition, to be used by the UE while in a connected state to determine a condition of the UE as either the stationary condition or the non-stationary condition. The UE may be configured with one or more configurations by the network while the UE is in RRC connected state. The different configurations may be provided to the UE either concurrently or sequentially or at independent time instants when the UE is in RRC connected state. The UE may apply differently the received configurations based on its RRC state, e.g., the UE may perform or operate differently, or have a different behavior when UE is in RRC connected state than when the UE is in RRC idle or inactive states.

For example, the UE may use or implement different stationary evaluation configurations (such as state-specific stationary evaluation configurations) depending on the state of the UE (e.g., the UE may use a first configuration while in a connected state, or use a second configuration while in an idle or inactive state). Thus, different configurations may be used by a UE to determine its condition as either stationary or non-stationary. For example, the first configuration for connected UE may indicate that the UE should compare its connected cell (the cell the UE is connected to) to a set of cells (stationary monitoring area is the set of cells), while the second configuration for idle or inactive state UE may indicate that the UE should compare the strongest cell measured by the UE (e.g., a cell for which the UE has measured a reference signal having a highest reference signal received power (RSRP)) to a same or different set of cells that was indicated by the first configuration. And/or, the first configuration may indicate a stationary monitoring area at a first level or granularity, e.g., a first stationary monitoring area that includes a set of cells, while the second configuration may indicate a stationary monitoring area at a second level or granularity, e.g., a second stationary monitoring area that includes a set of beams.

Also, the configuration (e.g., stationary evaluation configuration) provided to configure the UE may indicate or may include a first stationary monitoring area (e.g., one or more cells) and a second stationary monitoring area (e.g., one or more beams). The UE may be configured to report its condition to the network with respect to both the first stationary monitoring area and the second stationary monitoring area. For example, the UE may determine and report that the UE is stationary with respect to the one or more cells of the first stationary monitoring area (e.g., UE is connected to a cell that is part of the one or more cells of the first stationary monitoring area), and that the UE is non-stationary with respect to the one or more beams of the second stationary monitoring area (e.g., UE is not using or has not selected a beam within the second stationary monitoring area, or is using a beam for communication that is not part of the beams of the second stationary monitoring area). Thus, the configuration may indicate multiple stationary monitoring areas (e.g., two different monitoring areas indicating different groups of cells or different sets of beams) for which the condition (stationary condition or non-stationary condition) of the UE should be determined and reported to the network. These multiple stationary monitoring areas may be at the same level or granularity, e.g., both stationary monitoring areas indicated in terms of cells, or these multiple stationary monitoring areas may be provided at different levels or granularities, e.g., a first stationary monitoring area indicated as a set of cells and a second stationary monitoring area indicated as a set of beams. A level or granularity of a stationary monitoring area may be, or may include, one or more cells, a location or area, or one or more beams (e.g., levels for stationary monitoring areas may be at the location level or area level, a cell level, or a beam level).

Alternatively, the configuration (e.g., stationary evaluation configuration) provided to the UE may be or may include two configurations, where a first configuration indicates a first stationary monitoring area, and a second configuration indicates a second stationary monitoring area, to cause the user device to evaluate and report the condition of the user device or UE (stationary or non-stationary) with respect to each of the first and second stationary monitoring areas. Both the configurations may be provided at the same time (e.g., UE configured with both configurations at the same time) for evaluation and reporting. In another alternative, a gNB or RAN node may separately configure the UE, e.g., at different times and/or via separate control messages or configuration messages. For example, when a beam level non-stationary condition is evaluated by the user device or UE (e.g., with respect to a stationary monitoring area that includes a beam or set of beams), the gNB or RAN node may configure cell level stationary condition or configure UE to perform evaluation of its condition with respect to a cell or group of cells.

Various applications, use cases, and/or or wireless functions may be improved and/or optimized if a UE condition (e.g., the UE is in a stationary condition or a non-stationary condition) with respect to a stationary monitoring area of one or more UEs is provided to a network node, e.g., such as energy savings via a more selective or restricted paging of a UE only within a certain area or a specific cell(s) or via only specific beam(s) where the UE is, or is expected to be or use. For example, if the network knows, or has estimated, that a UE will or should be within or inside 1 or 2 cells, or has estimated that the UE is likely using a specific beam (or subset of beams), then that UE can be paged (e.g., network transmits a paging message to the UE) only to a smaller area (e.g., paging messages to UE may be sent only via those cell(s) where UE is located or expected or likely to be located). Or if network node knows or has estimated that the UE is using (or is expected or predicted to use at a particular time period) a beam or subset of beams, then the UE may be paged only via this beam or smaller subset of beams, e.g., to conserve power and/or conserve resources. Likewise, other applications, such as load balancing of traffic, mobility and/or traffic steering may be improved in a wireless network if a network node(s) are provided with information indicating a current condition (e.g., stationary or non-stationary) of one or more UEs. These are examples, and other applications may be improved and/or optimized based on the network receiving stationary condition information (e.g., which may include information indicating a condition of the UE (stationary or non-stationary), time or time duration information for the condition, and/or location information for the UE associated with the condition or when the condition was determined) for one or more UEs.

With respect to the method of FIG. 2, the stationary monitoring area may include at least one of the following: an area; a location or group of locations; one or more cells; one or more beams; one or more synchronization signal block (SSB) beams; or one or more channel state information-reference signal (CSI-RS) beams.

With respect to the method of FIG. 2, the stationary condition information may include: an indication of a condition of the user device, as either the stationary condition or the non-stationary condition with respect to the stationary monitoring area; and a time, a timing or a time duration for the condition of the user device (UE).

With respect to the method of FIG. 2, the stationary condition information may further include location information for the user device (UE), comprising at least a location, a beam or a cell for the user device.

With respect to the method of FIG. 2, the stationary condition information may further include location information for the user device (UE) when or while the condition of the user device was determined, wherein the location information includes at least one of the following: a location of the user device; a beam the user device is using for communication or has selected for communication while in a connected state; a strongest beam measured by the user device while the user device is in an idle or an inactive state; a cell the user device is connected to while the user device is in the connected state; and/or a strongest cell measured by the user device, or a cell having a strongest reference signal or beam measured by the user device, while the user device is in the idle state or the inactive state.

With respect to the method of FIG. 2, the determining the stationary condition information may include: determining, by the user device, a location, a beam or a cell for the user device; comparing the location, the beam or the cell for the user device to the stationary monitoring area; and, determining, based on the comparing, a condition of the user device as either stationary or non-stationary.

With respect to the method of FIG. 2, the stationary monitoring area may include an area, wherein the determining the stationary condition information for the user device includes: comparing a location of the user device to the area; determining that the user device is in the stationary condition if the location of the user device is inside the area, and determining that the user device is in the non-stationary condition if the location of the user device is outside the area.

With respect to the method of FIG. 2, the stationary monitoring area may include one or more cells, wherein the determining the stationary condition information for the user device includes: determining a cell for the user device; comparing the cell for the user device to the one or more cells; determining that the user device is in the stationary condition if the cell for the user device is a cell of or part of the one or more cells; and/or determining that the user device is in a non-stationary condition if the cell for the user device is not a cell of or part of the one or more cells.

With respect to the method of FIG. 2, the cell for the user device may include at least one of: a cell that the user device is connected to if the user device is in a connected state; or a strongest cell reference signal from a cell if the user device is in an idle state or an inactive state.

With respect to the method of FIG. 2, the stationary monitoring area may include one or more beams, wherein the determining the stationary condition information for the user device includes: determining a beam for the user device; comparing the beam for the user device to the one or more beams; determining that the user device is in the stationary condition if the beam for the user device is a beam of or part of the one or more beams; and determining that the user device is in a non-stationary condition if the beam for the user device is not a beam of or part of the one or more beams.

With respect to the method of FIG. 2, the beam for the user device may include at least one of: a beam that the user device is using for communication or selected for communication if the user device is in a connected state; or a strongest beam, or strongest reference signal associated with the beam, if the user device is in an idle state or an inactive state.

With respect to the method of FIG. 2, the determining the stationary condition information for the user device may include at least one of: determining a timing information and a location information for the user device when the user device transitioned from the non-stationary condition to the stationary condition with respect to the stationary monitoring area; determining a timing information and a location information for the user device when the user device transitioned from the stationary condition to the non-stationary condition with respect to the stationary monitoring area; determining a timing information and a location information for the user device when the user device changed location information while remaining in the stationary condition with respect to the stationary monitoring area; wherein the timing information includes at least one of a time of occurrence or a time duration; and wherein the location information for the user device includes at least one of a location for the user device, a beam for the user device, or a cell for the user device.

With respect to the method of FIG. 2, the transmitting may include: logging, by the user device, the stationary condition information for the user device; and transmitting, by the user device to the network node, the report including the logged stationary condition information for the user device.

With respect to the method of FIG. 2, the configuration is received by the user device while the user device is in a connected state, the method further including: transitioning, by the user device, from a connected state to an idle state or inactive state; logging the stationary condition information for the user device while the user device is at least in the idle state or the inactive state; transitioning, by the user device, from the idle or the inactive state to the connected state; wherein the transmitting includes transmitting, by the user device after transitioning to the connected state, the logged stationary condition information for the user device.

With respect to the method of FIG. 2, the logging may include at least one of: event based logging that is triggered, started and/or stopped based on the user device detecting that the user device has transitioned between the stationary condition and the non-stationary condition; or periodic logging where the user device periodically logs the stationary condition information, after logging has been started based on the user device determining that the user device is in a stationary condition or has transitioned to a stationary condition.

With respect to the method of FIG. 2, the user device is considered to be in a stationary condition or inside the stationary monitoring area based on one or more of the following: a location of the user device is inside the area or inside the location or the group of locations; the user device, in a connected state, is connected to a cell of the one or more cells; the user device, in a connected state, is communicating or has selected for communication, a beam of the one or more beams, or of the one or more SSB beams or of the one or more CSI-RS beams; the user device, in an idle state or an inactive state, receives a reference signal for a beam having a signal strength that is greater than a signal strength of the one or more beams, the one or more SSB beams or the one or more CSI-RS beams.

With respect to the method of FIG. 2, the determining the stationary condition information may include determining that the user device is in a stationary condition based on at least one of the following: the user device is connected to a cell that is inside the group of cells of the stationary monitoring area; the user device has selected a beam for communications or is using a beam for communications, or has detected a beam having a highest signal strength, that is within or part of a set of beams of the stationary monitoring area; or the user device has determined that its location is within or part of an area or a set of locations of the stationary monitoring area.

With respect to the method of FIG. 2, the determining the stationary condition information may include determining that the user device has transitioned from the non-stationary condition to the stationary condition, based on at least one of the following: the user device disconnecting from a first cell that is outside of or not part of a group of cells of the stationary monitoring area, and the user device connecting to a second cell that is inside of or part of the group of cells of the stationary monitoring area; the user device switching from using or selecting a first beam for communications or a first beam having a highest signal strength that is outside of or not part of a set of beams of the stationary monitoring area to using or selecting a second beam for communications or a second beam having a highest signal strength that is inside of or part of the set of beams of the stationary monitoring area; or the user device moving from a first location that is outside of or not part of an area or a set of locations of the stationary monitoring area to a second location that is inside of or part of the area or the set of locations of the stationary monitoring area.

With respect to the method of FIG. 2, the determining the stationary condition information includes determining that the user device is in a non-stationary condition based on at least one of the following: the user device is connected to a cell that is outside of or not part of the group of cells of the stationary monitoring area; the user device has selected a beam for communications or is using a beam for communications, or has detected a beam having a highest signal strength, that is outside or not part of a set of beams of the stationary monitoring area; or the user device has determined that its location is outside of or not part of an area or a set of locations of the stationary monitoring area.

With respect to the method of FIG. 2, the determining the stationary condition information includes determining that the user device has transitioned from the stationary condition to the non-stationary condition, based on at least one of the following: the user device disconnecting from a first cell that is inside of or part of a group of cells of the stationary monitoring area, and the user device connecting to a second cell that is outside of or not part of the group of cells of the stationary monitoring area; the user device switching from using or selecting a first beam for communications or a first beam having a highest signal strength that is inside of or part of a set of beams of the stationary monitoring area to using or selecting a second beam for communications or a second beam having a highest signal strength that is inside of or part of the set of beams of the stationary monitoring area; or the user device moving from a first location that is inside of or part of an area or a set of locations of the stationary monitoring area to a second location that is outside of or not part of the area or the set of locations of the stationary monitoring area.

With respect to the method of FIG. 2, the configuration may include a first configuration, including a first evaluation condition or a first station monitoring area, to be used by the user device while in an idle state or inactive state to determine a condition of the user device as either the stationary condition or the non-stationary condition; and a second configuration, including a second evaluation condition or a second stationary monitoring area that is different than the first evaluation condition, to be used by the user device while in a connected state to determine a condition of the user device as either the stationary condition or the non-stationary condition.

With respect to the method of FIG. 2, the method may further include: receiving, by the user device, a capability request; and transmitting, by the user device, a capability response indicating that the user device has a capability to determine and/or report stationary condition information for the user device.

With respect to the method of FIG. 2, the stationary condition information may include, for one or more conditions determined for the user device, information indicating: a condition of the user device as either a stationary condition or a non-stationary condition; a time, a timing or a time duration information for the condition of the user device; and a beam, a cell or a location for the user device when the condition for the user device was determined.

With respect to the method of FIG. 2, the configuration may include a first configuration for determining and reporting a stationary condition information with respect to a first stationary monitoring area, and a second configuration for determining and reporting a stationary condition information with respect to a second stationary monitoring area that is different from the first stationary monitoring area.

With respect to the method of FIG. 2, the determining the stationary condition information for the user device may include determining a first stationary condition information for the user device based on the first stationary monitoring area and a second stationary condition information based on the second stationary monitoring area; and wherein the transmitting includes transmitting by the user device to a network node, the report including the first stationary condition information and the second stationary condition information for the user device. The first and second stationary monitoring areas may be indicated based on at least one of the following: the first stationary monitoring area and the second stationary monitoring area are provided at a same level, including a level of either one or more locations or an area, one or more cells, or one or more beams; the first stationary monitoring area and the second stationary monitoring area are provided at different levels, wherein a level includes one or more locations or an area, one or more cells, or one or more beams; the first stationary monitoring area is indicated as one or more cells, and the second stationary monitoring area is indicated as one or more beams; the first stationary monitoring area is indicated as one or more cells, and the second stationary monitoring area is indicated as an area or a plurality of locations; or the first stationary monitoring area is indicated as one or more beams, and the second stationary monitoring area is indicated as an area or a plurality of locations.

With respect to the method of FIG. 2, the stationary condition information for the user device may include at least one of the following: a time stamp(s) or a time duration that the user device was in a stationary condition, and location information for the user device indicating a beam selected or used by the user device, a location of the user device, or a cell of the user device, while in the stationary condition; a time stamp for when the user device transitioned from the non-stationary condition to the stationary condition, and location information for the user device indicating a beam selected or used by the user device, a location of the user device, or a cell of the user device, while in the stationary condition, after leaving or transitioning from the non-stationary condition; a time stamp(s) or a time duration that the user device was in a non-stationary condition, and location information for the user device indicating a beam selected or used by the user device, a location of the user device, or a cell of the user device, while in the non-stationary condition; or a time stamp for when the user device transitioned from the stationary condition to the non-stationary condition, and location information for the user device indicating a beam selected or used by the user device, a location of the user device, or a cell of the user device, while in the non-stationary condition, after leaving or transitioning from the stationary condition; an indicator or indication that the user device transitioned from the stationary condition to the non-stationary condition; and/or an indicator or indication that the user device transitioned from the non-stationary condition to the stationary condition.

Various illustrative examples are shown and/or described that allow a network node to configure a UE with a configuration, which may be referred to as a stationary evaluation configuration. Configuring the UE or sending the configuration (e.g., stationary evaluation configuration) to the UE, may cause the UE to determine and report stationary condition information for the UE with respect to a stationary monitoring area. The stationary evaluation configuration may indicate, for example, a stationary monitoring area (e.g., one or more locations, an area, one or more cells, or one or more beams or any combination of those), and a stationary evaluation condition that should be evaluated by the UE with respect to the stationary monitoring area to determine a condition of the UE (e.g., determine whether the UE is stationary or non-stationary). For example, a stationary evaluation configuration may indicate a stationary monitoring area of cell 1, and a stationary evaluation condition that indicates that the UE is stationary if inside the cell 1, and is non-stationary if located outside of cell 1. Or, the stationary evaluation configuration may indicate two stationary monitoring areas (e.g., stationary monitoring area 1, and stationary monitoring area 2), and a stationary evaluation condition for each of these stationary monitoring areas. In response to receiving this stationary evaluation configuration, the UE may, e.g., one or more times, measure or determine its condition (e.g., as in a stationary condition or a non-stationary condition) with respect to each of the stationary monitoring areas 1 and 2, based on the stationary evaluation conditions for each.

The UE may log (e.g., record or store in memory or storage) this information (stationary condition information, including the UE condition) if the UE is in idle state or inactive state, and then later the UE may send a report to a network node when the UE is in a connected state to report this stationary condition information to the network (or network node). Alternatively, the UE may simply directly report this stationary condition information to a network node if the UE is in a connected state, for example. The stationary condition information included in the report may include various information, such as (for one or more instances or measurements of the condition of the UE, and for each of the stationary monitoring areas) whether the UE is stationary or non-stationary, a time (e.g., when the UE entered or exited the condition), timing or time duration for the condition (e.g., indicating when or for how long then UE was in this condition), a location of the UE (e.g., a location, a cell and/or a beam for the UE or that was used by the UE) when this condition was determined, etc., and possibly other information.

The condition of the UE (e.g., stationary condition or non-stationary condition) may be a condition that tests or indicates whether or not a UE remains in an area (e.g., a stationary monitoring area), which may be defined by a cell or multiple cells, a beam such as a SSB (synchronization signal block) beam, a list of SSBs, a location, an area or group of locations, etc. There may be different levels of being stationary, and the stationary condition information determined and reported by the UE may provide one or more instances of this condition measurement or determination of the UE's degree of being stationary (e.g., such as being stationary, or being non-stationary with respect to the stationary monitoring area). For example, a condition or stationary condition of a UE may indicate that the UE is stationary in the sense that the UE has a fixed location (provided by coordinates x, y, z) so UE does not move at all. Or the UE may be semi-stationary in that the UE moves within a limited area (e.g., within a cell, or among two beams or among two cells or within a limited number of beams or cells) without exiting or going outside of this limited area (a stationary monitoring area). This limited area can be defined in several ways: Movement within a beam (e.g., movement by UE while still using or communicating, or selecting for communications, this SSB or SSB beam) or within a limited number of SSBs or within a limited number of transitions where the maximum number is indicated by a threshold (e.g., up to one or two SSB transitions). Or the UE may be semi-stationary within an area, a volume, or 3-dimensional volume (with x, y, z coordinates of the UE compared to outer edge of the area or volume that is the stationary monitoring area). Thus, this definition of semi-stationary, the UE is allowed to move, but within a restricted area or in a restricted way. This is described herein as being stationary, since the UE is located within the stationary monitoring area.

Note that the UE may be considered to be stationary, even though the UE may be moving within the stationary monitoring area (SMA), such as the UE moving within a group of locations of the SMA, moving within the area of the SMA, moving within the one or more cells of the SMA (e.g., still connected to the cell or still measuring a strongest cell as being one of the cells of the stationary monitoring area), or moving while still using or still selecting as strongest the one or more beams of the SMA, which define the stationary monitoring area. Note that a stationary monitoring area may be defined in different ways, or at different levels, such as an area, one or more locations, one or more cells, and/or one or more beams, or a combination thereof, as examples of different stationary monitoring areas.

There may be differing degrees of being stationary or non-stationary, and instead of two values (stationary, non-stationary), e.g., for example, multiple values or degree of stationariness or degrees of being stationary may be indicated with a number or value within a range, e.g., 0 to 100 or within a percentage of stationariness, and also with a possible use of one stationary monitoring area or possibly using multiple stationary monitoring areas at a same level and/or size, or stationary monitoring areas provided at different levels and/or sizes (e.g., where a level of a stationary monitoring area may be at a location or area level, a cell(s) level, or a beam level). Different sizes of stationary monitoring areas may include, e.g., using different sizes of an area, different numbers of cells, and/or different numbers of beams, for two different stationary monitoring areas.

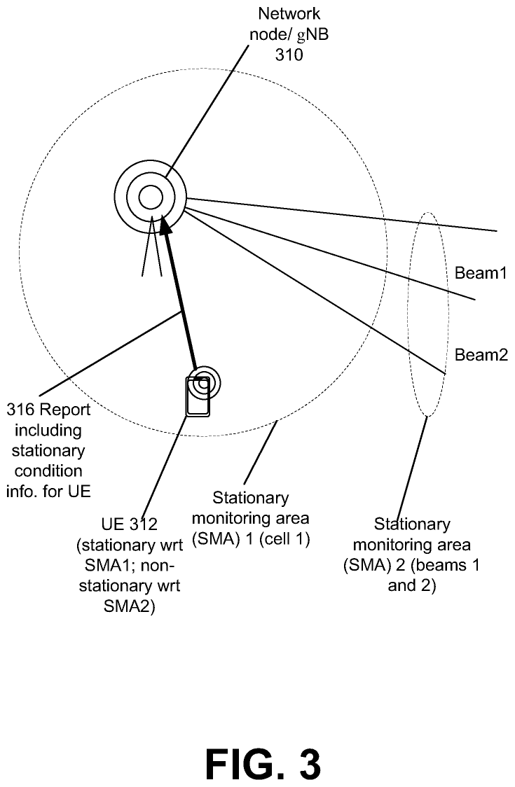

FIG. 3 is a diagram illustrating two stationary monitoring areas. A network node or gNB 310 may be in communication with a UE 312. A first stationary monitoring area (SMA1) may be a cell 1, while a second stationary monitoring area (SMA2) may be beams 1 and 2. In this example, the UE 312 may be located within cell 1, and thus, is in a stationary condition with respect to SMA1/cell 1; while the UE 312 is outside of beams 1 and 2 (e.g., UE 312 does not use or has not selected beam 1 or beam 2 for communication, but rather UE may use a different beam for communication with network node 310 that is not beam 1 or beam 2), and thus, UE 312 is non-stationary with respect to SMA2 (where SMA2 is defined as a group or set of beams including beam 1 and beam 2). The UE 312 may determine stationary condition information, e.g., which may include the UE's condition (stationary condition or non-stationary condition) with respect to each of SMA1 and SMA2, location information for the UE (e.g., within cell 1, and/or the UE was using beam 3, and/or x, y, z coordinates or GPS coordinates or location of the UE, for example) when the condition(s) were determined by the UE with respect to the SMAs, a time, a timing or a time duration information for each condition (e.g., indicating when the UE entered such condition, or for how long the UE remained in such condition, or when it exited this condition), and possibly other information. At 316, the UE 312 may either directly, or possibly after logging this information, may send a report to network node 310 that includes this stationary condition information.

As noted, the stationary evaluation configuration may indicate, for example, a stationary monitoring area(s)(s) (e.g., an area, one or more cells, or one or more beams or any combination of these), and a stationary evaluation condition that should be evaluated by the UE with respect to the stationary monitoring area to determine whether the UE is stationary or non-stationary, and possibly other configuration information or details, or configuration parameters. The stationary evaluation configuration (e.g., indicating one or more stationary monitoring areas and one or more stationary evaluation conditions to be evaluated by the UE, and then reported to the network) can be configured both by the OAM (Operations, Administration, and Maintenance) entity of the network, or any other network node or network entity, for example, the gNB or RAN node or by the gNB-CU in case of split architecture. The network, such as the OAM or network node, may use minimization of drive test (MDT) mechanisms or techniques to configure the UE and then for the UE to report or provide feedback to the network with the stationary condition information. MDT may be or may include a standardized mechanism or protocol to allow the UE to generally provide network data or feedback to the network, e.g., where the network (e.g., gNB or OAM or other network entity) configures the UE with a configuration, and the UE reports measurement logs with the requested data or information that was configured for measurement and reporting.

The network (e.g., gNB, gNB-CU or other network node, or OAM) may provide the stationary evaluation configuration to the UE via dedicated signaling from a gNB (or gNB-CU), or via broadcasted system information (e.g., broadcasted as part of a system information block (SIB)) broadcast by a gNB(s), gNB-CU(s) or RAN node(s).

The received stationary evaluation configuration enables the UE to monitor the condition (e.g., stationary condition or non-stationary condition) of the UE and determine when the UE enters a stationary monitoring area (e.g., an area, a cell, an SSB/beam, SSB list, a location or group of locations), e.g., where the UE may be instructed to report its condition (and other information such as time or time duration and location information) when entering a stationary condition (e.g., transitioning from a non-stationary condition to a stationary condition) or exiting a stationary condition (e.g., transitioning from a stationary condition to a non-stationary condition) with respect to a stationary monitoring area. For example, the stationary evaluation configuration may instruct the UE to log and report any changes in condition for the stationary monitoring area (e.g., report its condition each time the UE enters or exits a stationary condition, or when a location (e.g., location or beam) of the UE changes while inside the stationary monitoring area, or to determine this information periodically while inside the stationary monitoring area, and then send a report with this logged stationary condition information, for example.

The configuration for UEs in RRC Idle or Inactive states enables them to determine entering the stationary monitoring area where the condition (stationary or non-stationary condition) of the UE is evaluated and to log information related to this UE condition (e.g., log whether the UE entered the stationary condition or exited stationary condition with respect to the stationary monitoring area, a time when this transition (enter or exit) occurred, and/or for how long the UE remained in this condition, and/or a location and/or beam of the UE when this transition occurred, as examples of information that may be logged and/or reported). The stationary evaluation configuration may be transmitted to the UE while the UE is in a connected state, for example.

Logging may be or may include, for example: 1) Periodic logging: UE logs with a certain period whether it is stationary or not, 2) event based logging, where the UE logs stationary condition information based on or triggered by a specific event (e.g., logging triggered when UE enters or exits a stationary or non-stationary condition, with respect to a specific SMA(s)), and/or 3) Event based and periodic logging: The entering event can be when the stationariness is observed by the UE which triggers the logging to start at the UE side. The UE continues then to log periodically until it observes an exiting event, namely the event that stationariness condition is violated.

If a UE is in RRC connected state then the network can monitor through reported stationary condition information or measurements whether the UE is stationary or non-stationary with respect to a stationary monitoring area, according to a stationary evaluation configuration provided or communicated by the network to the UE. The stationary evaluation configuration (e.g., which may indicate one or more of a stationary monitoring area, a stationary monitoring condition to be evaluated by the UE related to the stationary monitoring area, may be provided or communicated to the UE via the management plane, namely OAM or core network towards a gNB and then forwarded to the UE.

For example, when a UE determines that it has entered or exited a stationary monitoring area, the UE may then begin reporting stationary condition information for the UE, such as, for example: whether the UE is stationary or non-stationary; a time or time duration during which during which the UE remained in that condition (stationary or non-stationary) or a time or a time duration when UE exited from that condition (stationary or non-stationary). A time-stamp may be indicated when the UE entered a stationary condition (e.g., transitioned from non-stationary condition to stationary condition) or exited the stationary condition (e.g., transitioned from non-stationary condition to stationary condition), and/or a location information of the UE (e.g., location of UE, beam used by the UE for communication and/or cell that the UE is connected to, or strongest beam or cell measured by UE) when such transition occurred. For example, in a connected state, the UE may directly report its stationary condition information to the gNB that it is connected to. Also, while a UE is in a non-connected state (such as in either idle or inactive states), the UE may log its stationary condition information over a period of time and then later send a report to a gNB or RAN node that includes the logged stationary condition information after the UE connects to a gNB.

A UE using the configuration provided by the network can evaluate UE condition (e.g., to determine whether the UE is in a stationary condition or a non-stationary condition) at a given point in time. The UE evaluates the UE condition and detection of a stationary or non-stationary condition may act as a trigger to the UE to start the reporting (or a trigger to start the logging in idle or inactive states) of measurements to the network. The UE as an example may report to the network the stationary condition information, e.g., when the UE entered stationary condition, for how long the UE was in the stationary condition, and when it is violated/exited (when the UE exited the stationary condition or transitioned from stationary condition to the non-stationary condition). It is possible that when the UE receives the stationary evaluation configuration, the UE is not inside the stationary monitoring area (e.g., not in a stationary condition with respect to that stationary monitoring area), so the UE may need to detect or determine when it enters the stationary monitoring area (enters a stationary condition with respect to the stationary monitoring area). In some cases, the UE entering of the stationary monitoring area may cause the UE to initiate logging of stationary condition information for the UE. So monitoring also when the condition is entered may be important in some cases in that it can act as a trigger in the logging or reporting of the stationary condition information.

Also, in some cases, the stationary condition information from connected mode or idle/inactive mode UEs can be used in the input of an AI/ML (machine learning) model residing at the network side (e.g., gNB, gNB-CU) to train the ML model so that the network can predict UE condition (e.g., stationary condition or non-stationary condition) at a given time.

As noted, determining a condition (e.g., stationary condition or non-stationary condition) of a UE, or using such stationary condition information to predict a likely or most probable condition (stationary or non-stationary) of the UE with respect to one or more stationary monitoring areas may allow energy savings, as this may assist the network in more selectively transmitting paging messages to a UE only to cells or via beams where the UE is most likely to be in the next time period. This selective or restrictive paging by the gNB may be accomplished, e.g., by the gNB switching off some of the beams and/or omitting to transmit the paging message via one or more beams or cells where the UE is not likely to be located or using such beams. This enables the network to switch off cells/beams to achieve network energy savings and still be able to page UEs that are predicted to be located in stationary monitoring areas at a certain point in time with high probability. Cells or beams that are non-stationary with respect to a stationary monitoring are (e.g., cells or beams outside of the stationary monitoring area) a can be switched off to achieve energy savings via selective paging of the UE.

Also, for example, a condition of the UE (e.g., stationary condition or non-stationary condition) may be RRC (radio resource control) state independent or RRC state dependent. In the RRC state independent case, the UE condition (e.g., stationary condition or non-stationary condition) may be evaluated across RRC states independently of whether UE is in RRC connected state, or RRC idle and Inactive states, even though the evaluation condition may be slightly different per RRC state. A condition (e.g., stationary condition or non-stationary condition) for a RRC Connected UE may be determined based on the beam (e.g., SSB/CSI-RS beam) or location/location area or cell ID or other identifier signifying a location. For UEs in RRC Idle or Inactive state the UE condition (e.g., stationary condition or non-stationary condition) may be determined based on the SSB/CSI-RS beam or cell ID that the UE hears/reports with the strongest signal strength or based on the location/location area where the UE resides. In the RRC state dependent case, the UE may evaluate its condition (e.g., determine that it is in a stationary condition or in a non-stationary condition) per RRC state. If UE changes RRC states, then the determination of its condition (as either stationary or non-stationary) may be interrupted. For example, if a condition of the UE (stationary or non-stationary) is evaluated based on a given SSB beam, the UE in this example is in a stationary condition when the UE is connected to the SSB beam (or measures or detects the SSB beam with the maximum power) and while the UE does not switch its RRC state, for example.

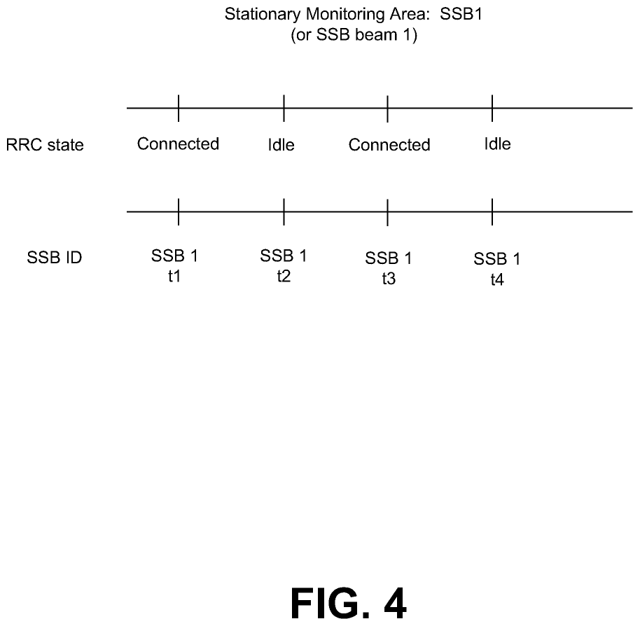

FIG. 4 is a diagram illustrating how a condition of the UE (e.g., stationary condition or non-stationary condition can be evaluated with respect to different RRC states of the UE when a stationary monitoring area is SSB1 (synchronization signal block beam 1). In this example, assume that UE is provided the stationary evaluation configuration (e.g., which may include information indicating the stationary monitoring area (indicating SSB1 in this example) and a stationary evaluation condition to be evaluated by the UE to determine the UE condition) at time t1 when it is in a RRC connected state. In case of RRC state independent definition, the UE will determine its condition (stationary condition or non-stationary condition) with respect to the stationary monitoring area from time t1 to time t4. In case of RRC state dependent definition, the UE will exit stationary condition when it switches to idle state at time t2 so it will be considered to be in a stationary condition only from t1 to t2, because in this example, the transition of UE from connected state to idle or inactive state causes the condition of the UE to transition from stationary condition to non-stationary condition.

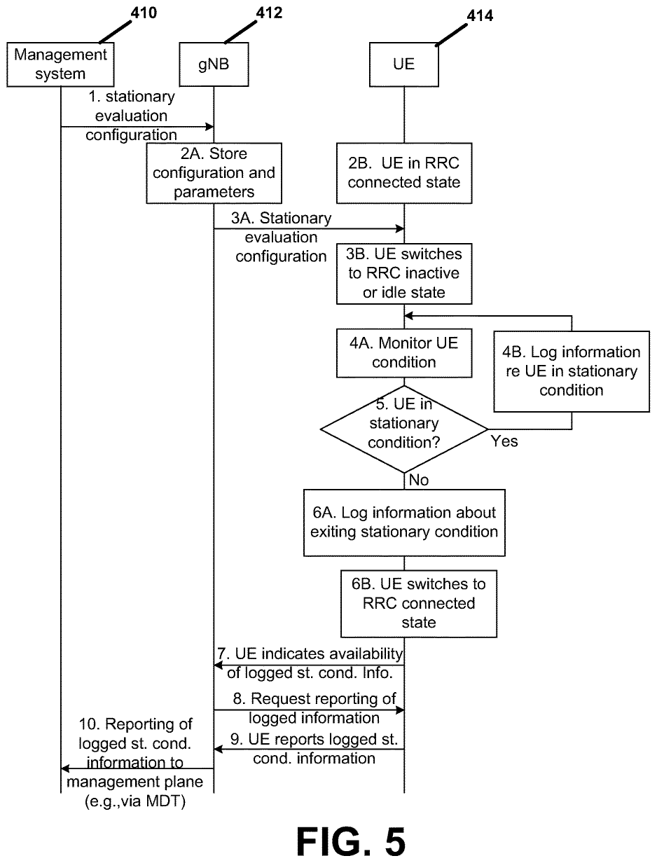

FIG. 5 is a diagram illustrating configuring a UE, and the UE logging and reporting stationary condition information based on the received stationary evaluation configuration. At 1, the stationary evaluation configuration is forwarded by management system (e.g., OAM) 410 to gNB 412. At 2A, the gNB 412 stores the stationary evaluation configuration, and at 3A the gNB 412 forwards the stationary evaluation configuration to UE 414 (where the UE 414 is now in a connected state, step 2B). At 3B, UE transitions from active state to idle or inactive state. At 4A, the UE monitors the configured condition. At 5, the UE determines the UE condition as either in a stationary condition or in a non-stationary condition. At 4B, if the UE is in a stationary condition, the UE logs stationary condition information for the UE indicating that the UE is in a stationary condition. At 6A, if the UE is not in the stationary condition (or has exited the stationary condition), the UE 414 logs stationary condition information for the UE that indicates that the UE has transitioned from the stationary condition to the non-stationary condition. At step 6B, the UE transitions to a connected state, e.g., by established a connection with gNB 412. The stationary evaluation configuration is provided or transmitted to UE when the UE is in RRC connected state but the logging may take place when the UE is in RRC idle or inactive state, for example. The UE logs that it is stationary (in a stationary condition) until it exits the stationary condition (transitions to non-stationary condition). Once the UE detects that the UE's location is outside the locations that are part of the stationary monitoring area (e.g., area, cell(s), or beam(s) or a combination of those) according to the stationary evaluation configuration, the UE logs the first non-stationary location and stops or ceases the logging. This procedure in FIG. 5 is shown for idle or inactive state UEs. At 7, after the UE 414 has transitioned to connected mode, the UE indicates to the gNB 412 an available logging report (provides an indication that a logging report is available) that includes stationary condition information. At 8, the UE receives a request for the logged report, and at 9 the UE 414 transmits the report that includes the logged stationary condition information to gNB 412. At 10, the gNB reports or forwards the stationary condition information to the management system or OAM.

For example, with respect to FIG. 5, if UE is in connected state then the UE may report to network node every stationary location (every stationary condition) it detects based on the configuration and no logging takes place (e.g., logging can be omitted in connected state, since UE may directly report this stationary condition information to network node). Note that configuration according to Immediate MDT may be provided through the management plane (signaling-based or management-based MDT) as in step 1 even though this is not mandatory. Configuration from gNB to UE could be provided through normal RRM methods in step 3A of FIG. 5. For example, the network may configure a UE with the stationary condition. This can be done when network detects that a UE is connected to a certain SSB beam that is in the stationary list. In this example, the UE 414 is expected to only report to the network when it exits the stationary condition (and connects e.g., to a different beam) so this condition can act as a trigger for the reporting.

At step 4A of FIG. 5, UE is monitoring its condition according to the received stationary evaluation configuration and does a check whether this current SSB or strongest SSB of the UE belongs to (or is included in) the provided list of SSBs (the stationary monitoring area). The list could be also a single location, e.g., cell/SSB beam/detailed location. Once the UE is connected to a location (e.g., cell, beam, detailed location) not in the provided list indicating the stationary monitoring area, it detects that the stationary condition is violated (UE has now exited stationary condition, and is now non-stationary with respect to this stationary monitoring area) due to its location not in the list of SSBs or detecting a best SSB that is not in the list of SSBs that is the stationary monitoring area. The UE detecting that the UE is in a non-stationary condition (or UE detecting that it has exited stationary condition) triggers UE logging at step 6A of FIG. 5 if UE is idle/inactive (or correspondingly reporting if UE is connected to the network). UE in some scenarios only logs to the network that non-stationary condition is detected through a flag indicating that stationary condition is violated (and thus UE is now in a non-stationary condition). In some scenarios UE may also include the non-stationary condition detection trigger. UE may additionally and optionally indicate to the network a list of locations (e.g., beams, cells, or locations) that meet the stationary condition that UE was connected to and a time duration that it was connected to each of those. UE can also optionally indicate the new location (e.g., SSB beam not in the stationary list/stationary monitoring area) where the UE was connected and time during which the UE stayed connected to this location. When the UE 412 is in a connected state the network may derive this information through measurements (e.g., network already knows the cells the UE is connected to and/or beams the UE uses for communication and/or the UE locations, while UE is in connected state). Still a UE in connected state may still provide the same measurements (stationary condition information) as when the UE 414 is in inactive or idle state logs, so network should provide it with the corresponding configuration. For example since reporting time may not coincide with the time that UE stationary condition/non-stationary condition is observed, a connected mode UE will still need to provide the network the time stamp when it entered the stationary condition or the time stamp when the condition was exited.

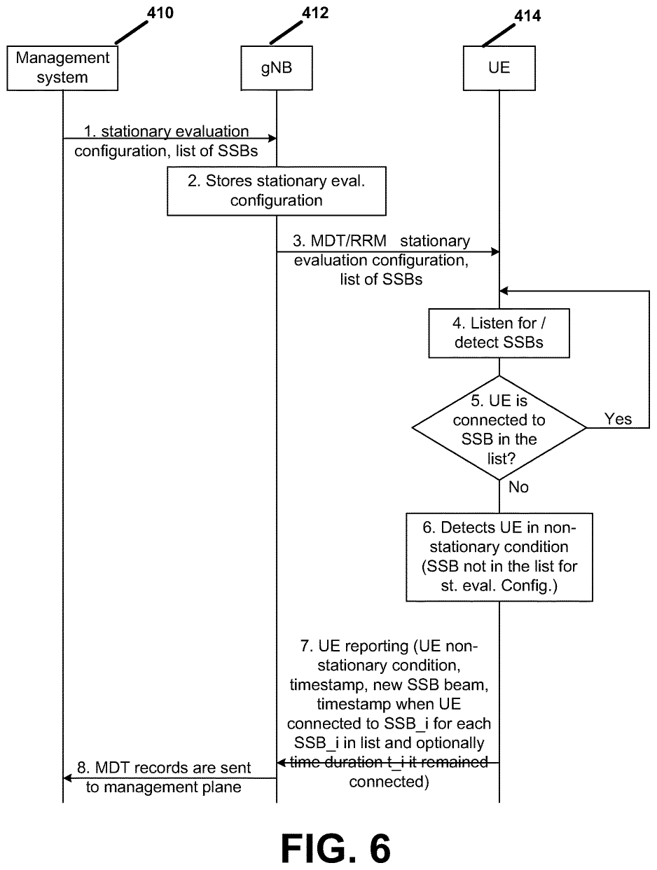

FIG. 6 is a diagram illustrating operation where a stationary monitoring area is based on a list of beams (e.g., SSBs/SSB beams) and the UE transitions from a stationary condition to a non-stationary condition. Steps 1, 2 and 3 are same as steps 1, 2A and 3A of FIG. 5. In this example, the UE provides to the network all the beams that the UE has been connected to where the UE was in a stationary condition, together with the timestamp when each of these beams is detected. At 4, the UE listens or receives, or measures, SSBs, and at 5, determines whether its SSB/beam (e.g., selected or used for communication) is on the list of SSBs for the stationary monitoring area (and thus, determines whether the UE is stationary condition or in a non-stationary condition at 6). At 7, the UE 414 reports to gNB 412, information indicating that UE 414 transitioned to non-stationary condition (exited stationary condition), a timestamp of such transition, a new SSB beam used by the UE after such transition, and/or a timestamp and SSB index for each SSB in the list that it used for connection on the list and thus while in stationary condition, and time duration that the UE remained in a stationary condition using such SSB/beam. At 8, the stationary condition information report is forwarded by gNB 412 to management system 410.

Thus, for FIG. 6, the UE 414 may calculate the overall duration spent connected to a given SSB. The UE also reports the new beam where non-stationariness was detected and the time-stamp when non-stationariness is detected. One method of doing the reporting by the UE is to introduce a new IE (new information element, or new field within a message), e.g., stationary State IE through which the UE provides to the network an indicator on whether it considers itself to be stationary or non-stationary with respect to the provided configuration (e.g., with respect to the stationary monitoring area of the received stationary evaluation configuration). If the stationary monitoring area is an exact location, then the stationary State flag being true by UE would indicate that the UE considers itself to be totally stationary (and thus located at the specific location of the stationary monitoring area). If the stationary monitoring area is with respect to an SSB (or beam) list, then a UE could report a stationary State flag being true if even though it moves it still stays within the list of SSBs that determine its condition (as either stationary condition or non-stationary condition). If the stationary monitoring area is with respect to a fixed location, then a UE could indicate to network that stationary State flag is false when it slightly moves and is no longer located at the indicated location of the stationary monitoring area.

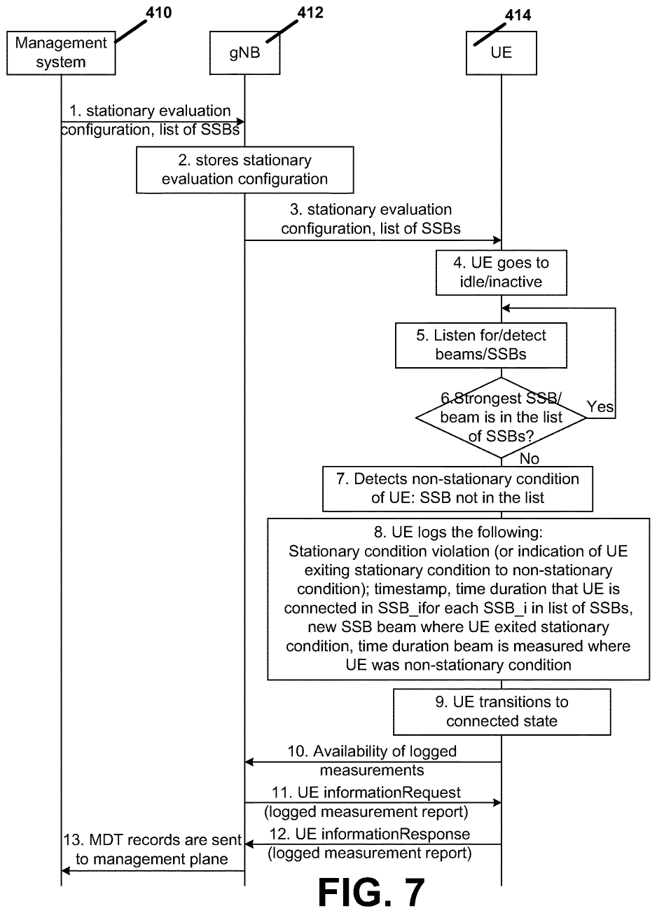

FIG. 7 is a diagram illustrating operation where a stationary monitoring area is based on a list of beams (e.g., SSBs/SSB beams) and the idle state or inactive state UE transitions from a stationary condition to a non-stationary condition. Steps 1-3 are the same as steps 1-3 of FIG. 6. At step 4, UE transitions from connected state to an idle state or inactive state. At 5, the UE 414 detects or measures receives SSBs/beams, and determines the strongest SSB that it receives. At 6, the UE 414 determines whether the strongest SSB in on the list of SSBs for the stationary monitoring area. If strongest beam/SSB is on the list, this indicates that UE is in (or still in) a stationary condition. At 7, if the strongest measured SSB/beam is not on the list of SSBs for the stationary monitoring area, this indicates that the UE has exited stationary condition (and has transitioned from stationary condition to non-stationary condition). At 8, the UE logs stationary condition information for this transition to non-stationary condition, e.g., including the stationary condition violation (e.g., indicating transition to non-stationary condition), a time stamp, a time duration that UE is connected to SSB for each SSB in the list, and when the UE finally exited the stationary condition (by detecting/measuring a strongest SSB that is not on the list of SSBs for the stationary monitoring area). At 10-13, a report including logged stationary condition information is forwarded from the UE 414 to the management system 410 via gNB 412.

Thus, for example, in FIG. 7, the stationary evaluation configuration indicates a list of SSBs, and UE movement within this list of SSBs (e.g., where strongest SSB on this list of SSBs) is considered a UE stationary condition). This list of SSBs may, for example, be limited to a single SSB. UE is configured by the network to start logging of information when UE detects that a stationary condition is violated (UE has transitioned from stationary to non-stationary condition) (assuming that UE when configured is already in stationary condition). UE checks the strongest SSB/beam to determine its condition. If the beam is in the provided list of SSBs (for the stationary monitoring area) by the network then UE assumes that the stationary condition is met (UE is in stationary condition). If the UE at some point measures that the strongest beam is outside the provided list of SSBs for the stationary monitoring area, then the UE flags this event by logging that the stationary condition is violated (the UE has transitioned from a stationary condition to a non-stationary condition) and timestamps the event. In addition, the UE may log the amount of time when it measures that the strongest beam is stationary though this can be also calculated by the network by looking into the logged time-stamps. In case UE is configured by the network while it is connected on a non-stationary beam (not on list of SSBs for stationary monitoring area), the logged or the reported information will correspond to non-stationary condition. UE can indicate to network that it has logged measurements available by indicating expiration of stationary condition (UE transition to non-stationary condition) in stationary expiration in RRCSetupComplete/RRCResumeComplete/RRCReconfigurationComplete messages. Those measurements may include logging of a non-stationary condition. The retrieval of this information can follow the existing UEInformationRequest/Response procedures.

Some examples will now be described, based on the description and figures provided herein.

Example 1. A method comprising: receiving (210, FIG. 2), by a user device (e.g., UE 312, FIG. 3, UE 414, FIGS. 5-7), a configuration (e.g., a stationary evaluation configuration) for determining and reporting (e.g., to configure or cause the user device or UE to determine and report) a stationary condition information (e.g., which may include a condition, such as a stationary condition or a non-stationary condition) for the user device with respect to a stationary monitoring area, wherein inside the stationary monitoring area the user device is considered to be in a stationary condition, and outside the stationary monitoring area the user device is considered to be in a non-stationary condition, the configuration including information indicating the stationary monitoring area (e.g., where the stationary monitoring area may be or may include one or more locations, an area or group of areas (which may correspond to a plurality of locations), one or more cells, and/or one or more beams, e.g., see FIG. 3 for examples of stationary monitoring areas (SMAs), including SMA1 (cell 1) and SMA2 (beams 1 and 2)); determining (220, FIG. 2; operation 5, FIG. 5; operation 6, FIG. 6) the stationary condition information (e.g., which may include determining a condition of the UE as either stationary or non-stationary, and possibly other information) for the user device based on the stationary monitoring area (e.g., with respect to the area, the one or more cells, and/or the one or more beams of the SMA); and transmitting (230, FIG. 2), by the user device to a network node (e.g., gNB 412), a report including the stationary condition information for the user device. For example, at 316 (FIG. 3) the UE may transmit a report indicating that the UE is stationary with respect to SMA1 (cell 1, FIG. 3), and non-stationary with respect to SMA2 (beams 1 and 2, FIG. 3). See FIGS. 5-7. Operation 10 of FIG. 5, operation 7 of FIG. 6, and operation 12 of FIG. 7 show examples of the UE 414 transmitting the stationary condition information to the network node or gNB 412.

Example 2. The method of example 1, wherein the stationary monitoring area includes at least one of the following: an area; a location or group of locations; one or more cells (e.g., stationary monitoring area 1 (SMA1) includes cell 1, FIG. 3); one or more beams (e.g., SMA2 includes beams 1 and 2, FIG. 3); one or more synchronization signal block (SSB) beams; or one or more channel state information-reference signal (CSI-RS) beams.

Example 3. The method of any of examples 1-2, wherein the stationary condition information includes: an indication of a condition of the user device, as either the stationary condition or the non-stationary condition with respect to the stationary monitoring area; and a time, a timing or a time duration for the condition of the user device.

Example 4. The method of example 3, wherein the stationary condition information further includes location information for the user device, comprising at least a location, a beam or a cell for the user device.

Example 5. The method of any of examples 3-4, wherein the stationary condition information further includes location information for the user device when or while the condition of the user device was determined, wherein the location information includes at least one of the following: a location of the user device (e.g., GPS coordinates, x, y, z coordinates of the UE, or other location information for the UE); a beam the user device is using for communication or has selected for communication while in a connected state; a strongest beam measured by the user device while the user device is in an idle or an inactive state; a cell the user device is connected to while the user device is in the connected state (e.g., such as cell 1, FIG. 3, for the UE); and/or a strongest cell measured by the user device, or a cell having a strongest reference signal or beam measured by the user device, while the user device is in the idle state or the inactive state.

Example 6. The method of example 1, wherein the determining the stationary condition information includes: determining, by the user device, a location, a beam or a cell for the user device; comparing the location, the beam or the cell for the user device to the stationary monitoring area; determining, based on the comparing, a condition of the user device as either stationary or non-stationary. For example, operations 4A and 5 of FIG. 5 show that the UE may monitor the UE condition (e.g., determine the UE location, cell, and/or beams in use by the UE, and compare this/these to the stationary monitoring area), to determine whether the UE is stationary (e.g., inside the SMA), or non-stationary (e.g., outside of the SMA).

Example 7. The method of any of examples 1-6, wherein the stationary monitoring area includes an area, wherein the determining the stationary condition information for the user device includes: comparing a location of the user device to the area; determining that the user device is in the stationary condition if the location of the user device is inside the area, and determining that the user device is in the non-stationary condition if the location of the user device is outside the area.

Example 8. The method of any of examples 1-6, wherein the stationary monitoring area includes one or more cells (e.g., stationary monitoring area 1 (SMA1) is or includes cell 1, FIG. 3) wherein the determining the stationary condition information for the user device includes: determining a cell for the user device; comparing the cell for the user device to the one or more cells (e.g., comparing the cell that the UE is connected to or strongest cell, to the cell of the SMA1); determining that the user device is in the stationary condition if the cell for the user device is a cell of or part of the one or more cells (of the SMA); determining that the user device is in a non-stationary condition if the cell for the user device is not a cell of or part of the one or more cells (e.g., determining that the UE is in a non-stationary condition if the cell the UE is connected to is not within the one or more cells of the stationary monitoring area (SMA)).

Example 9. The method of example 8 wherein the cell for the user device includes at least one of: a cell that the user device is connected to if the user device is in a connected state; or a strongest cell reference signal from a cell if the user device is in an idle state or an inactive state.

Example 10. The method of any of examples 1-6, wherein the stationary monitoring area includes one or more beams, wherein the determining the stationary condition information for the user device includes: determining a beam for the user device; comparing the beam for the user device to the one or more beams; determining that the user device is in the stationary condition if the beam for the user device is a beam of or part of the one or more beams; determining that the user device is in a non-stationary condition if the beam for the user device is not a beam of or part of the one or more beams.

Example 11. The method of example 10, wherein the beam for the user device includes at least one of: a beam that the user device is using for communication or selected for communication if the user device is in a connected state; or a strongest beam, or strongest reference signal associated with the beam, if the user device is in an idle state or an inactive state.

Example 12. The method of any of examples 1-11, wherein the determining the stationary condition information for the user device includes at least one of: determining a timing information and a location information for the user device when the user device transitioned from the non-stationary condition to the stationary condition with respect to the stationary monitoring area; determining a timing information and a location information for the user device when the user device transitioned from the stationary condition to the non-stationary condition with respect to the stationary monitoring area; determining a timing information and a location information for the user device when the user device changed location information while remaining in the stationary condition with respect to the stationary monitoring area; wherein the timing information includes at least one of: a time of occurrence of a condition, a time duration of the condition, or a time when the user device entered or exited the condition; and wherein the location information for the user device includes at least one of a location for the user device, a beam for the user device, or a cell for the user device.

Example 13. The method of any of examples 1-12, wherein the transmitting includes: logging (e.g., see operation 6A, FIG. 5; operation 8, FIG. 7), by the user device, the stationary condition information for the user device; and transmitting, by the user device to the network node, the report including the logged stationary condition information for the user device (e.g., see operation 9, FIG. 5; operation 12, FIG. 7; 316, FIG. 3).

Example 14. The method of any of examples 1-13, wherein the configuration is received by the user device while the user device is in a connected state, the method further comprising: transitioning, by the user device, from a connected state to an idle state or inactive state; logging the stationary condition information for the user device while the user device is at least in the idle state or the inactive state; transitioning, by the user device, from the idle or the inactive state to the connected state; wherein the transmitting includes transmitting, by the user device after transitioning to the connected state, the logged stationary condition information for the user device. For example, in FIG. 5, the UE receives stationary evaluation configuration at operation 1, switches to inactive or idle state at operation 3B, logs stationary condition information at 4B and 6A, FIG. 5; and transmits logged stationary condition information to gNB 412 at operation 9, FIG. 5.

Example 15. The method of example 14, wherein the logging includes at least one of: event based logging that is triggered, started and/or stopped based on the user device detecting that the user device has transitioned between the stationary condition and the non-stationary condition; or periodic logging where the user device periodically logs the stationary condition information, after logging has been started based on the user device determining that the user device is in a stationary condition or has transitioned to a stationary condition.

Example 16. The method of example 2, wherein the user device is considered to be in a stationary condition or inside the stationary monitoring area based on one or more of the following: a location of the user device is inside the area or inside the location or the group of locations; the user device, in a connected state, is connected to a cell of the one or more cells; the user device, in a connected state, is communicating or has selected for communication, a beam of the one or more beams, or of the one or more SSB beams or of the one or more CSI-RS beams; the user device, in an idle state or an inactive state, receives a reference signal for a beam having a signal strength that is greater than a signal strength of the one or more beams, the one or more SSB beams or the one or more CSI-RS beams.

Example 17. The method of example 1, wherein the determining the stationary condition information includes determining that the user device is in a stationary condition based on at least one of the following: the user device is connected to a cell that is inside the group of cells of the stationary monitoring area; the user device has selected a beam for communications or is using a beam for communications, or has detected a beam having a highest signal strength, that is within or part of a set of beams of the stationary monitoring area; or the user device has determined that its location is within or part of an area or a set of locations of the stationary monitoring area.

Example 18. The method of example 1, wherein the determining the stationary condition information includes determining that the user device has transitioned from the non-stationary condition to the stationary condition, based on at least one of the following: the user device disconnecting from a first cell that is outside of or not part of a group of cells of the stationary monitoring area, and the user device connecting to a second cell that is inside of or part of the group of cells of the stationary monitoring area; the user device switching from using or selecting a first beam for communications or a first beam having a highest signal strength that is outside of or not part of a set of beams of the stationary monitoring area to using or selecting a second beam for communications or a second beam having a highest signal strength that is inside of or part of the set of beams of the stationary monitoring area; or the user device moving from a first location that is outside of or not part of an area or a set of locations of the stationary monitoring area to a second location that is inside of or part of the area or the set of locations of the stationary monitoring area.

Example 19. The method of example 1, wherein the determining the stationary condition information includes determining that the user device is in a non-stationary condition based on at least one of the following: the user device is connected to a cell that is outside of or not part of the group of cells of the stationary monitoring area; the user device has selected a beam for communications or is using a beam for communications, or has detected a beam having a highest signal strength, that is outside or not part of a set of beams of the stationary monitoring area; or the user device has determined that its location is outside of or not part of an area or a set of locations of the stationary monitoring area.

Example 20. The method of example 1, wherein the determining the stationary condition information includes determining that the user device has transitioned from the stationary condition to the non-stationary condition, based on at least one of the following: the user device disconnecting from a first cell that is inside of or part of a group of cells of the stationary monitoring area, and the user device connecting to a second cell that is outside of or not part of the group of cells of the stationary monitoring area; the user device switching from using or selecting a first beam for communications or a first beam having a highest signal strength that is inside of or part of a set of beams of the stationary monitoring area to using or selecting a second beam for communications or a second beam having a highest signal strength that is inside of or part of the set of beams of the stationary monitoring area; or the user device moving from a first location that is inside of or part of an area or a set of locations of the stationary monitoring area to a second location that is outside of or not part of the area or the set of locations of the stationary monitoring area.

Example 21. The method of any of examples 1-20, wherein the configuration includes: a first configuration, including a first evaluation condition or a first station monitoring area, to be used by the user device while in an idle state or inactive state to determine a condition of the user device as either the stationary condition or the non-stationary condition; and a second configuration, including a second evaluation condition or a second stationary monitoring area that is different than the first evaluation condition, to be used by the user device while in a connected state to determine a condition of the user device as either the stationary condition or the non-stationary condition.

Example 22. The method of any of examples 1-21, further comprising: receiving, by the user device, a capability request; transmitting, by the user device, a capability response indicating that the user device has a capability to determine and/or report stationary condition information for the user device.

Example 23. The method of any of examples 1-22, wherein the stationary condition information includes, for one or more conditions determined for the user device, information indicating: a condition of the user device as either a stationary condition or a non-stationary condition; a time, a timing or a time duration information for the condition of the user device; and a beam, a cell or a location for the user device when the condition for the user device was determined.

Example 24. The method of any of examples 1-23: wherein the configuration includes a first configuration for determining and reporting a stationary condition information with respect to a first stationary monitoring area, and a second configuration for determining and reporting a stationary condition information with respect to a second stationary monitoring area that is different from the first stationary monitoring area.

Example 25. The method of example 24: wherein the determining the stationary condition information for the user device includes determining a first stationary condition information for the user device based on the first stationary monitoring area and a second stationary condition information based on the second stationary monitoring area; and wherein the transmitting includes transmitting by the user device to a network node, the report including the first stationary condition information and the second stationary condition information for the user device.

Example 26. The method of any of examples 24-25, wherein the first and second stationary monitoring areas are indicated based on at least one of the following: the first stationary monitoring area and the second stationary monitoring area are provided at a same level, including a level of either one or more locations or an area, one or more cells, or one or more beams; the first stationary monitoring area and the second stationary monitoring area are provided at different levels, wherein a level includes one or more locations or an area, one or more cells, or one or more beams; the first stationary monitoring area is indicated as one or more cells, and the second stationary monitoring area is indicated as one or more beams; the first stationary monitoring area is indicated as one or more cells, and the second stationary monitoring area is indicated as an area or a plurality of locations; or the first stationary monitoring area is indicated as one or more beams, and the second stationary monitoring area is indicated as an area or a plurality of locations.

Example 27. The method of any of examples 1-26, wherein stationary condition information for the user device further includes at least one of the following: a time stamp(s) or a time duration that the user device was in a stationary condition, and location information for the user device indicating a beam selected or used by the user device, a location of the user device, or a cell of the user device, while in the stationary condition; a time stamp for when the user device transitioned from the non-stationary condition to the stationary condition, and location information for the user device indicating a beam selected or used by the user device, a location of the user device, or a cell of the user device, while in the stationary condition, after leaving or transitioning from the non-stationary condition; a time stamp(s) or a time duration that the user device was in a non-stationary condition, and location information for the user device indicating a beam selected or used by the user device, a location of the user device, or a cell of the user device, while in the non-stationary condition; or a time stamp for when the user device transitioned from the stationary condition to the non-stationary condition, and location information for the user device indicating a beam selected or used by the user device, a location of the user device, or a cell of the user device, while in the non-stationary condition, after leaving or transitioning from the stationary condition; an indicator or indication that the user device transitioned from the stationary condition to the non-stationary condition; and/or an indicator or indication that the user device transitioned from the non-stationary condition to the stationary condition.

Example 28. An apparatus comprising: at least one processor; and at least one memory including computer program code; the at least one memory and the computer program code configured to, with the at least one processor, cause the apparatus at least to perform the method of any of examples 1-27.

Example 29. A non-transitory computer-readable storage medium comprising instructions stored thereon that, when executed by at least one processor, are configured to cause a computing system to perform the method of any of examples 1-27.

Example 30. An apparatus comprising means for performing the method of any of examples 1-27.

Example 31. An apparatus comprising: means for receiving, by a user device, a configuration for determining and reporting a stationary condition information for the user device with respect to a stationary monitoring area, wherein inside the stationary monitoring area the user device is considered to be in a stationary condition, and outside the stationary monitoring area the user device is considered to be in a non-stationary condition, the configuration including information indicating the stationary monitoring area; means for determining the stationary condition information for the user device based on the stationary monitoring area; and means for transmitting, by the user device to a network node, a report including the stationary condition information for the user device.

Example 32. An apparatus comprising a non-transitory computer-readable storage medium comprising instructions stored thereon that, when executed by at least one processor, are configured to cause a computing system to: receive, by a user device, a configuration for determining and reporting a stationary condition information for the user device with respect to a stationary monitoring area, wherein inside the stationary monitoring area the user device is considered to be in a stationary condition, and outside the stationary monitoring area the user device is considered to be in a non-stationary condition, the configuration including information indicating the stationary monitoring area; determine the stationary condition information for the user device based on the stationary monitoring area; and transmit, by the user device to a network node, a report including the stationary condition information for the user device.

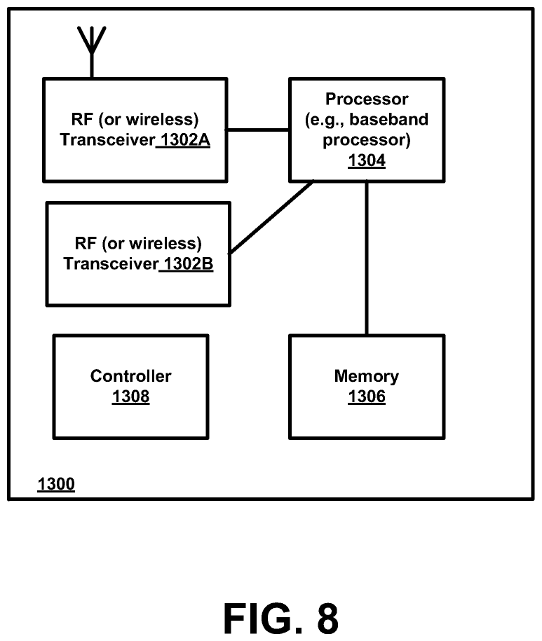

Example 33. An apparatus comprising: at least one processor (e.g., 1304, FIG. 8); and at least one memory (e.g., 1306, FIG. 8) including computer program code; the at least one memory and the computer program code configured to, with the at least one processor, cause the apparatus at least to: receive (210, FIG. 2), by a user device (UE 414, FIGS. 5-7), a configuration for determining and reporting a stationary condition information for the user device with respect to a stationary monitoring area, wherein inside the stationary monitoring area the user device is considered to be in a stationary condition, and outside the stationary monitoring area the user device is considered to be in a non-stationary condition, the configuration including information indicating the stationary monitoring area; determine (220, FIG. 2) the stationary condition information for the user device based on the stationary monitoring area; and transmit (230, FIG. 2), by the user device to a network node (e.g., gNB 412, FIGS. 5-7), a report including the stationary condition information for the user device.

Example 34. The apparatus of example 33, wherein the stationary monitoring area includes at least one of the following: an area; a location or group of locations; one or more cells; one or more beams; one or more synchronization signal block (SSB) beams; or one or more channel state information-reference signal (CSI-RS) beams.

Example 35. The apparatus of any of examples 33-34, wherein the stationary condition information includes: an indication of a condition of the user device, as either the stationary condition or the non-stationary condition with respect to the stationary monitoring area; and a time, a timing or a time duration for the condition of the user device.

Example 36. The apparatus of example 35, wherein the stationary condition information further includes location information for the user device, comprising at least a location, a beam or a cell for the user device.

Example 37. The apparatus of any of examples 35-36, wherein the stationary condition information further includes location information for the user device when or while the condition of the user device was determined, wherein the location information includes at least one of the following: a location of the user device; a beam the user device is using for communication or has selected for communication while in a connected state; a strongest beam measured by the user device while the user device is in an idle or an inactive state; a cell the user device is connected to while the user device is in the connected state; and/or a strongest cell measured by the user device, or a cell having a strongest reference signal or beam measured by the user device, while the user device is in the idle state or the inactive state.

Example 38. The apparatus of example 33, wherein the at least one processor and the computer program code configured to cause the apparatus to determine the stationary condition information includes the at least one processor and the computer program code configured to cause the apparatus to: determine, by the user device, a location, a beam or a cell for the user device; compare the location, the beam or the cell for the user device to the stationary monitoring area; and determine, based on the comparing, a condition of the user device as either stationary or non-stationary.

Example 39. The apparatus of any of examples 33-38 wherein the stationary monitoring area includes an area, wherein the determining the stationary condition information for the user device includes: comparing a location of the user device to the area; determining that the user device is in the stationary condition if the location of the user device is inside the area, and determining that the user device is in the non-stationary condition if the location of the user device is outside the area.

Example 40. The apparatus of any of example 33-38, wherein the stationary monitoring area includes one or more cells, wherein the determining the stationary condition information for the user device includes: determining a cell for the user device; comparing the cell for the user device to the one or more cells; determining that the user device is in the stationary condition if the cell for the user device is a cell of or part of the one or more cells; determining that the user device is in a non-stationary condition if the cell for the user device is not a cell of or part of the one or more cells.

Example 41. The apparatus of example 40 wherein the cell for the user device includes at least one of: a cell that the user device is connected to if the user device is in a connected state; or a strongest cell reference signal from a cell if the user device is in an idle state or an inactive state.

Example 42. The apparatus of any of examples 33-38, wherein the stationary monitoring area includes one or more beams, wherein the determining the stationary condition information for the user device includes: determining a beam for the user device; comparing the beam for the user device to the one or more beams; determining that the user device is in the stationary condition if the beam for the user device is a beam of or part of the one or more beams; determining that the user device is in a non-stationary condition if the beam for the user device is not a beam of or part of the one or more beams.

Example 43. The apparatus of example 42, wherein the beam for the user device includes at least one of: a beam that the user device is using for communication or selected for communication if the user device is in a connected state; or a strongest beam, or strongest reference signal associated with the beam, if the user device is in an idle state or an inactive state.

Example 44. The apparatus of any of examples 33-43, wherein the at least one processor and the computer program code configured to cause the apparatus to determine the stationary condition information for the user device includes the at least one processor and the computer program code configured to cause the apparatus to perform at least one of: determine a timing information and a location information for the user device when the user device transitioned from the non-stationary condition to the stationary condition with respect to the stationary monitoring area; determine a timing information and a location information for the user device when the user device transitioned from the stationary condition to the non-stationary condition with respect to the stationary monitoring area; determine a timing information and a location information for the user device when the user device changed location information while remaining in the stationary condition with respect to the stationary monitoring area; wherein the timing information includes at least one of: a time of occurrence of a condition, a time duration of the condition, or a time when the user device entered or exited the condition; and wherein the location information for the user device includes at least one of a location for the user device, a beam for the user device, or a cell for the user device.

Example 45. The apparatus of any of examples 33-44, wherein the at least one processor and the computer program code configured to cause the apparatus to transmit includes the at least one processor and the computer program code configured to cause the apparatus to: log, by the user device, the stationary condition information for the user device while the user device is in an idle or inactive state; and transmit the report, by the user device to the network node while the user device is in an active state, the report including the logged stationary condition information for the user device.

Example 46. The apparatus of any of examples 33-44, wherein the at least one processor and the computer program code configured to cause the apparatus to transmit includes the at least one processor and the computer program code configured to cause the apparatus to: transmit the report, by the user device to the network node while the user device is in a connected state, the report including the stationary condition information for the user device.

Example 47. The apparatus of any of examples 33-46, wherein the configuration is received by the user device while the user device is in a connected state, the method further comprising: transitioning, by the user device, from a connected state to an idle state or inactive state; logging the stationary condition information for the user device while the user device is at least in the idle state or the inactive state; transitioning, by the user device, from the idle or the inactive state to the connected state; wherein the transmitting includes transmitting, by the user device after transitioning to the connected state, the logged stationary condition information for the user device.

Example 48. The apparatus of example 47, wherein the at least one processor and the computer program code configured to cause the apparatus to log includes the at least one processor and the computer program code configured to cause the apparatus to perform at least one of the following: perform event based logging that is triggered, started and/or stopped based on the user device detecting that the user device has transitioned between the stationary condition and the non-stationary condition; or perform periodically logging where the user device periodically logs the stationary condition information, after logging has been started based on the user device determining that the user device is in a stationary condition or has transitioned to a stationary condition.

Example 49. The apparatus of example 34, wherein the user device is considered to be in a stationary condition or inside the stationary monitoring area based on one or more of the following: a location of the user device is inside the area or inside the location or the group of locations; the user device, in a connected state, is connected to a cell of the one or more cells; the user device, in a connected state, is communicating or has selected for communication, a beam of the one or more beams, or of the one or more SSB beams or of the one or more CSI-RS beams; the user device, in an idle state or an inactive state, receives a reference signal for a beam having a signal strength that is greater than a signal strength of the one or more beams, the one or more SSB beams or the one or more CSI-RS beams.

Example 50. The apparatus of example 33, wherein the at least one processor and the computer program code configured to cause the apparatus to determine the stationary condition information includes the at least one processor and the computer program code configured to cause the apparatus to determine that the user device is in a stationary condition based on at least one of the following: the user device is connected to a cell that is inside the group of cells of the stationary monitoring area; the user device has selected a beam for communications or is using a beam for communications, or has detected a beam having a highest signal strength, that is within or part of a set of beams of the stationary monitoring area; or the user device has determined that its location is within or part of an area or a set of locations of the stationary monitoring area.

Example 51. The apparatus of example 33, wherein the determining the stationary condition information includes determining that the user device has transitioned from the non-stationary condition to the stationary condition, based on at least one of the following: the user device disconnecting from a first cell that is outside of or not part of a group of cells of the stationary monitoring area, and the user device connecting to a second cell that is inside of or part of the group of cells of the stationary monitoring area; the user device switching from using or selecting a first beam for communications or a first beam having a highest signal strength that is outside of or not part of a set of beams of the stationary monitoring area to using or selecting a second beam for communications or a second beam having a highest signal strength that is inside of or part of the set of beams of the stationary monitoring area; or the user device moving from a first location that is outside of or not part of an area or a set of locations of the stationary monitoring area to a second location that is inside of or part of the area or the set of locations of the stationary monitoring area.

Example 52. The apparatus of example 33, wherein the at least one processor and the computer program code configured to cause the apparatus to determine the stationary condition information includes the at least one processor and the computer program code configured to cause the apparatus to determine that the user device is in a non-stationary condition based on at least one of the following: the user device is connected to a cell that is outside of or not part of the group of cells of the stationary monitoring area; the user device has selected a beam for communications or is using a beam for communications, or has detected a beam having a highest signal strength, that is outside or not part of a set of beams of the stationary monitoring area; or the user device has determined that its location is outside of or not part of an area or a set of locations of the stationary monitoring area.

Example 53. The apparatus of example 33, wherein the at least one processor and the computer program code configured to cause the apparatus to determine the stationary condition information includes the at least one processor and the computer program code configured to cause the apparatus to determine that the user device is in a non-stationary condition based on at least one of the following: the user device disconnecting from a first cell that is inside of or part of a group of cells of the stationary monitoring area, and the user device connecting to a second cell that is outside of or not part of the group of cells of the stationary monitoring area; the user device switching from using or selecting a first beam for communications or a first beam having a highest signal strength that is inside of or part of a set of beams of the stationary monitoring area to using or selecting a second beam for communications or a second beam having a highest signal strength that is inside of or part of the set of beams of the stationary monitoring area; or the user device moving from a first location that is inside of or part of an area or a set of locations of the stationary monitoring area to a second location that is outside of or not part of the area or the set of locations of the stationary monitoring area.

Example 54. The apparatus of any of examples 33-53, wherein the configuration includes: a first configuration, including a first evaluation condition or a first station monitoring area, to be used by the user device while in an idle state or inactive state to determine a condition of the user device as either the stationary condition or the non-stationary condition; and a second configuration, including a second evaluation condition or a second stationary monitoring area that is different than the first evaluation condition, to be used by the user device while in a connected state to determine a condition of the user device as either the stationary condition or the non-stationary condition.

Example 55. The apparatus of any of examples 33-54, wherein the at least one processor and the computer program code are further configured to cause the apparatus to: receive, by the user device, a capability request; transmit, by the user device, a capability response indicating that the user device has a capability to determine and/or report stationary condition information for the user device.

Example 56. The apparatus of any of examples 33-55, wherein the stationary condition information includes, for one or more conditions determined for the user device, information indicating: a condition of the user device as either a stationary condition or a non-stationary condition; a time, a timing or a time duration information for the condition of the user device; and a beam, a cell or a location for the user device when the condition for the user device was determined.

Example 57. The apparatus of any of example 33-56: wherein the configuration includes a first configuration for determining and reporting a stationary condition information with respect to a first stationary monitoring area, and a second configuration for determining and reporting a stationary condition information with respect to a second stationary monitoring area that is different from the first stationary monitoring area.

Example 58. The apparatus of example 57: wherein the at least one processor and the computer program code configured to cause the apparatus to determine the stationary condition information for the user device includes the at least one processor and the computer program code configured to cause the apparatus to determine a first stationary condition information for the user device based on the first stationary monitoring area and a second stationary condition information based on the second stationary monitoring area; and wherein the at least one processor and the computer program code configured to cause the apparatus to transmit includes the at least one processor and the computer program code configured to cause the apparatus to transmit by the user device to the network node, the report including the first stationary condition information and the second stationary condition information for the user device.

Example 59. The apparatus of any of examples 57-58, wherein the first and second stationary monitoring areas are indicated based on at least one of the following: the first stationary monitoring area and the second stationary monitoring area are provided at a same level, including a level of either one or more locations or an area, one or more cells, or one or more beams; the first stationary monitoring area and the second stationary monitoring area are provided at different levels, wherein a level includes one or more locations or an area, one or more cells, or one or more beams; the first stationary monitoring area is indicated as one or more cells, and the second stationary monitoring area is indicated as one or more beams; the first stationary monitoring area is indicated as one or more cells, and the second stationary monitoring area is indicated as an area or a plurality of locations; or the first stationary monitoring area is indicated as one or more beams, and the second stationary monitoring area is indicated as an area or a plurality of locations.

Example 60. The apparatus of any of examples 33-59, wherein stationary condition information for the user device further includes at least one of the following: a time stamp(s) or a time duration that the user device was in a stationary condition, and location information for the user device indicating a beam selected or used by the user device, a location of the user device, or a cell of the user device, while in the stationary condition; a time stamp for when the user device transitioned from the non-stationary condition to the stationary condition, and location information for the user device indicating a beam selected or used by the user device, a location of the user device, or a cell of the user device, while in the stationary condition, after leaving or transitioning from the non-stationary condition; a time stamp(s) or a time duration that the user device was in a non-stationary condition, and location information for the user device indicating a beam selected or used by the user device, a location of the user device, or a cell of the user device, while in the non-stationary condition; or a time stamp for when the user device transitioned from the stationary condition to the non-stationary condition, and location information for the user device indicating a beam selected or used by the user device, a location of the user device, or a cell of the user device, while in the non-stationary condition, after leaving or transitioning from the stationary condition; an indicator or indication that the user device transitioned from the stationary condition to the non-stationary condition; and/or an indicator or indication that the user device transitioned from the non-stationary condition to the stationary condition.

FIG. 8 is a block diagram of a wireless station or node (e.g., UE, user device, AP, BS, eNB, gNB, RAN node, network node, TRP, or other node) 1300 according to an example embodiment. The wireless station 1300 may include, for example, one or more (e.g., two as shown in FIG. 8) RF (radio frequency) or wireless transceivers 1302A, 1302B, where each wireless transceiver includes a transmitter to transmit signals and a receiver to receive signals. The wireless station also includes a processor or control unit/entity (controller) 1304 to execute instructions or software and control transmission and receptions of signals, and a memory 1306 to store data and/or instructions.

Processor 1304 may also make decisions or determinations, generate frames, packets or messages for transmission, decode received frames or messages for further processing, and other tasks or functions described herein. Processor 1304, which may be a baseband processor, for example, may generate messages, packets, frames or other signals for transmission via wireless transceiver 1302 (1302A or 1302B). Processor 1304 may control transmission of signals or messages over a wireless network, and may control the reception of signals or messages, etc., via a wireless network (e.g., after being down-converted by wireless transceiver 1302, for example). Processor 1304 may be programmable and capable of executing software or other instructions stored in memory or on other computer media to perform the various tasks and functions described above, such as one or more of the tasks or methods described above. Processor 1304 may be (or may include), for example, hardware, programmable logic, a programmable processor that executes software or firmware, and/or any combination of these. Using other terminology, processor 1304 and transceiver 1302 together may be considered as a wireless transmitter/receiver system, for example.

In addition, referring to FIG. 8, a controller (or processor) 1308 may execute software and instructions, and may provide overall control for the station 1300, and may provide control for other systems not shown in FIG. 8, such as controlling input/output devices (e.g., display, keypad), and/or may execute software for one or more applications that may be provided on wireless station 1300, such as, for example, an email program, audio/video applications, a word processor, a Voice over IP application, or other application or software.

In addition, a storage medium may be provided that includes stored instructions, which when executed by a controller or processor may result in the processor 1304, or other controller or processor, performing one or more of the functions or tasks described above.

According to another example embodiment, RF or wireless transceiver(s) 1302A/1302B may receive signals or data and/or transmit or send signals or data. Processor 1304 (and possibly transceivers 1302A/1302B) may control the RF or wireless transceiver 1302A or 1302B to receive, send, broadcast or transmit signals or data.

Embodiments of the various techniques described herein may be implemented in digital electronic circuitry, or in computer hardware, firmware, software, or in combinations of them. Embodiments may be implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Embodiments may also be provided on a computer readable medium or computer readable storage medium, which may be a non-transitory medium. Embodiments of the various techniques may also include embodiments provided via transitory signals or media, and/or programs and/or software embodiments that are downloadable via the Internet or other network(s), either wired networks and/or wireless networks. In addition, embodiments may be provided via machine type communications (MTC), and also via an Internet of Things (IOT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer, or it may be distributed amongst a number of computers.

Furthermore, embodiments of the various techniques described herein may use a cyber-physical system (CPS) (a system of collaborating computational elements controlling physical entities). CPS may enable the embodiment and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various embodiments of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, embodiments may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments may be implemented in a computing system that includes a back-end component, e.g., as a data server, or that includes a middleware component, e.g., an application server, or that includes a front-end component, e.g., a client computer having a graphical user interface or a Web browser through which a user can interact with an embodiment, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described embodiments have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

1. An apparatus comprising:
at least one processor; and
at least one memory including computer program code;
the at least one memory and the computer program code configured to, with the at least one processor, cause the apparatus at least to:
receive, by a user device, a configuration for determining and reporting a stationary condition information for the user device with respect to a stationary monitoring area, wherein inside the stationary monitoring area the user device is considered to be in a stationary condition, and outside the stationary monitoring area the user device is considered to be in a non-stationary condition, the configuration including information indicating the stationary monitoring area;
determine the stationary condition information for the user device based on the stationary monitoring area; and
transmit, by the user device to a network node, a report including the stationary condition information for the user device.

2. The apparatus of claim 1, wherein the stationary monitoring area comprises at least one of the following:
an area;
a location or group of locations;
one or more cells;
one or more beams;
one or more synchronization signal block (SSB) beams; or
one or more channel state information-reference signal (CSI-RS) beams.

3. The apparatus of claim 1, wherein the stationary condition information comprises:
an indication of a condition of the user device, as either the stationary condition or the non-stationary condition with respect to the stationary monitoring area; and
a time, a timing or a time duration for the condition of the user device.

4. The apparatus of claim 1, wherein the stationary condition information comprises:
an indication of a condition of the user device, as either the stationary condition or the non-stationary condition with respect to the stationary monitoring area;
a time, a timing or a time duration for the condition of the user device; and
location information for the user device, comprising at least a location, a beam or a cell for the user device.

5. (canceled)

6. The apparatus of claim 1, wherein the at least one processor and the computer program code configured to cause the apparatus to determine the stationary condition information comprises the at least one processor and the computer program code configured to cause the apparatus to:
determine, by the user device, a location, a beam or a cell for the user device;
compare the location, the beam or the cell for the user device to the stationary monitoring area; and
determine, based on the comparing, a condition of the user device as either stationary or non-stationary.

7. The apparatus of claim 1, wherein the stationary monitoring area comprises an area, wherein the determining the stationary condition information for the user device comprises:
comparing a location of the user device to the area;
determining that the user device is in the stationary condition if the location of the user device is inside the area, and
determining that the user device is in the non-stationary condition if the location of the user device is outside the area.

8. The apparatus of claim 1, wherein the stationary monitoring area comprises one or more cells, wherein the determining the stationary condition information for the user device comprises:
determining a cell for the user device;
comparing the cell for the user device to the one or more cells;
determining that the user device is in the stationary condition if the cell for the user device is a cell of or part of the one or more cells;
determining that the user device is in a non-stationary condition if the cell for the user device is not a cell of or part of the one or more cells.

9. (canceled)

10. The apparatus of claim 1, wherein the stationary monitoring area comprises one or more beams, wherein the determining the stationary condition information for the user device comprises:
determining a beam for the user device;
comparing the beam for the user device to the one or more beams;
determining that the user device is in the stationary condition if the beam for the user device is a beam of or part of the one or more beams;
determining that the user device is in a non-stationary condition if the beam for the user device is not a beam of or part of the one or more beams.

11. (canceled)

12. The apparatus of claim 1, wherein the at least one processor and the computer program code configured to cause the apparatus to determine the stationary condition information for the user device comprises the at least one processor and the computer program code configured to cause the apparatus to perform at least one of:
determine a timing information and a location information for the user device when the user device transitioned from the non-stationary condition to the stationary condition with respect to the stationary monitoring area;
determine a timing information and a location information for the user device when the user device transitioned from the stationary condition to the non-stationary condition with respect to the stationary monitoring area;
determine a timing information and a location information for the user device when the user device changed location information while remaining in the stationary condition with respect to the stationary monitoring area;
wherein the timing information includes at least one of: a time of occurrence of a condition, a time duration of the condition, or a time when the user device entered or exited the condition; and
wherein the location information for the user device comprises at least one of a location for the user device, a beam for the user device, or a cell for the user device.

13. The apparatus of claim 1, wherein the at least one processor and the computer program code configured to cause the apparatus to transmit comprises the at least one processor and the computer program code configured to cause the apparatus to:
log, by the user device, the stationary condition information for the user device while the user device is in an idle or inactive state; and
transmit the report, by the user device to the network node while the user device is in an active state, the report including the logged stationary condition information for the user device.

14. The apparatus of claim 1, wherein the at least one processor and the computer program code configured to cause the apparatus to transmit comprises the at least one processor and the computer program code configured to cause the apparatus to:
transmit the report, by the user device to the network node while the user device is in a connected state, the report including the stationary condition information for the user device.

15. The apparatus of claim 1, wherein the configuration is received by the user device while the user device is in a connected state, the method further comprising:
transitioning, by the user device, from a connected state to an idle state or inactive state;
logging the stationary condition information for the user device while the user device is at least in the idle state or the inactive state;
transitioning, by the user device, from the idle or the inactive state to the connected state;
wherein the transmitting comprises transmitting, by the user device after transitioning to the connected state, the logged stationary condition information for the user device.

16. (canceled)

17. The apparatus of claim 1, wherein the stationary monitoring area comprises at least one of the following:
an area;
a location or group of locations;
one or more cells;
one or more beams;
one or more synchronization signal block (SSB) beams; or
one or more channel state information-reference signal (CSI-RS) beams; and
wherein the user device is considered to be in a stationary condition or inside the stationary monitoring area based on one or more of the following:
a location of the user device is inside the area or inside the location or the group of locations;
the user device, in a connected state, is connected to a cell of the one or more cells;
the user device, in a connected state, is communicating or has selected for communication, a beam of the one or more beams, or of the one or more SSB beams or of the one or more CSI-RS beams; or
the user device, in an idle state or an inactive state, receives a reference signal for a beam having a signal strength that is greater than a signal strength of the one or more beams, the one or more SSB beams or the one or more CSI-RS beams.

18. The apparatus of claim 1, wherein the at least one processor and the computer program code configured to cause the apparatus to determine the stationary condition information comprises the at least one processor and the computer program code configured to cause the apparatus to determine that the user device is in a stationary condition based on at least one of the following:
the user device is connected to a cell that is inside the group of cells of the stationary monitoring area;
the user device has selected a beam for communications or is using a beam for communications, or has detected a beam having a highest signal strength, that is within or part of a set of beams of the stationary monitoring area; or
the user device has determined that its location is within or part of an area or a set of locations of the stationary monitoring area.

19. The apparatus of claim 1, wherein the determining the stationary condition information comprises determining that the user device has transitioned from the non-stationary condition to the stationary condition, based on at least one of the following:
the user device disconnecting from a first cell that is outside of or not part of a group of cells of the stationary monitoring area, and the user device connecting to a second cell that is inside of or part of the group of cells of the stationary monitoring area;
the user device switching from using or selecting a first beam for communications or a first beam having a highest signal strength that is outside of or not part of a set of beams of the stationary monitoring area to using or selecting a second beam for communications or a second beam having a highest signal strength that is inside of or part of the set of beams of the stationary monitoring area; or
the user device moving from a first location that is outside of or not part of an area or a set of locations of the stationary monitoring area to a second location that is inside of or part of the area or the set of locations of the stationary monitoring area.

20. The apparatus of claim 1, wherein the at least one processor and the computer program code configured to cause the apparatus to determine the stationary condition information comprises the at least one processor and the computer program code configured to cause the apparatus to determine that the user device is in a non-stationary condition based on at least one of the following:
the user device is connected to a cell that is outside of or not part of the group of cells of the stationary monitoring area;
the user device has selected a beam for communications or is using a beam for communications, or has detected a beam having a highest signal strength, that is outside or not part of a set of beams of the stationary monitoring area; or
the user device has determined that its location is outside of or not part of an area or a set of locations of the stationary monitoring area.

21. The apparatus of claim 1, wherein the at least one processor and the computer program code configured to cause the apparatus to determine the stationary condition information comprises the at least one processor and the computer program code configured to cause the apparatus to determine that the user device is in a non-stationary condition based on at least one of the following:
the user device disconnecting from a first cell that is inside of or part of a group of cells of the stationary monitoring area, and the user device connecting to a second cell that is outside of or not part of the group of cells of the stationary monitoring area;
the user device switching from using or selecting a first beam for communications or a first beam having a highest signal strength that is inside of or part of a set of beams of the stationary monitoring area to using or selecting a second beam for communications or a second beam having a highest signal strength that is inside of or part of the set of beams of the stationary monitoring area; or
the user device moving from a first location that is inside of or part of an area or a set of locations of the stationary monitoring area to a second location that is outside of or not part of the area or the set of locations of the stationary monitoring area.

22. The apparatus of claim 1, wherein the configuration comprises:
a first configuration, including a first evaluation condition or a first station monitoring area, to be used by the user device while in an idle state or inactive state to determine a condition of the user device as either the stationary condition or the non-stationary condition; and
a second configuration, including a second evaluation condition or a second stationary monitoring area that is different than the first evaluation condition, to be used by the user device while in a connected state to determine a condition of the user device as either the stationary condition or the non-stationary condition.

23. The apparatus of claim 1, wherein the at least one processor and the computer program code are further configured to cause the apparatus to:
receive, by the user device, a capability request;
transmit, by the user device, a capability response indicating that the user device has a capability to determine and/or report stationary condition information for the user device.

24. The apparatus of claim 1, wherein the stationary condition information comprises, for one or more conditions determined for the user device, information indicating:
a condition of the user device as either a stationary condition or a non-stationary condition;
a time, a timing or a time duration information for the condition of the user device; and
a beam, a cell or a location for the user device when the condition for the user device was determined.

25-28. (canceled)
